(19) United States
(12) Patent Application Publication
(10) Pub. No.: US 2013/0096981 A1
(43) Pub. Date: Apr. 18, 2013

(54) METHOD AND SYSTEM FOR OPTIMIZING COMMUNICATION ABOUT ENTERTAINMENT

(71) Applicants: Robert Todd Evans, Shaker Heights, OH (US); Jamison L. Waddell, Tucson, AZ (US); Adrian Chan, San Francisco, CA (US)

(72) Inventors: Robert Todd Evans, Shaker Heights, OH (US); Jamison L. Waddell, Tucson, AZ (US); Adrian Chan, San Francisco, CA (US)

(21) Appl. No.: 13/586,830

(22) Filed: Aug. 15, 2012

Related U.S. Application Data
(60) Provisional application No. 61/523,649, filed on Aug. 15, 2011.

(51) Int. Cl. G06Q 30/02

(52) U.S. Cl. CPC G06Q 30/0201
USPC 705/7.29

(57) ABSTRACT

A method for optimizing communication about entertainment events, including live music events. The method can include acquiring entertainment event data from a plurality of data sources, acquiring artist data, acquiring social media data, providing an application that allows a user of the application to access information associated with the entertainment event, wherein the user can save their favorite venues or artists, flag upcoming events, access special promotions, or share their plans and interests via social media, and creating a database, wherein the database includes information related to users, events, artists, venues, advertisers, and publications. The method may also include features for gamification of activity within the application and tracking of a “buzz” score to identify artists gaining in popularity.

### CROSS REFERENCE TO RELATED APPLICATION

This application claims priority to, and any other benefit of, U.S. Provisional Patent Application Ser. No. 61/523,649, filed on Aug. 15, 2011 and entitled Method and System for Optimizing Communication About Entertainment (Attorney Docket No. 34732/04000), which is hereby incorporated in its entirety by reference.

### BACKGROUND OF THE INVENTION

The present invention relates to optimizing communication about entertainment. It finds particular application in conjunction with, e.g., live music and will be described with particular reference thereto. Many entertainment communication channels are fragmented or narrowly focused and lack the ability to present a user with a comprehensive view of entertainment events and information. It will be appreciated, however, that the invention is also amenable to other applications.

### SUMMARY

According to one embodiment of the present invention, a method for optimizing communication about entertainment events, including acquiring entertainment event data from a plurality of data sources, acquiring artist data, wherein the artist is associated with the entertainment event, acquiring social media data, including a measure of social activity associated with the entertainment event or artist, providing an application that allows a user of the application to access information associated with the entertainment event, including location, date, time, tickets, venue, samples of the artist material, advertisements, promotions, articles, merchandise, or related events, wherein the user can save their favorite venues or artists, flag upcoming events, access special promotions, or share their plans and interests via social media, and creating a database, wherein the database includes information related to users, events, artists, venues, advertisers, and publications.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify the embodiments of this invention.

FIG. 1 illustrates a simplified, high-level flowchart showing exemplary steps associated with optimizing communication and awareness of live music events for a particular market;

FIG. 2 illustrates a flowchart showing exemplary steps associated with building an exemplary comprehensive live music event ecosystem database;

FIG. 3 illustrates a flowchart showing exemplary steps associated with acquiring exemplary comprehensive live music event venue and neighborhood information;

FIG. 4 illustrates a flowchart showing exemplary steps associated with acquiring exemplary comprehensive live music event “event” information;

FIG. 5 illustrates a flowchart showing exemplary steps associated with acquiring exemplary comprehensive live music event artist content and related information;

FIG. 6 illustrates a flowchart showing exemplary steps associated with acquiring exemplary comprehensive social media information and “buzz” about fans, artists, venues, and promoters;

FIG. 7 illustrates a flowchart showing exemplary steps associated with displaying exemplary live music event information;

FIG. 8 includes an exemplary screenshot of the application displaying exemplary “Discover Events” view information;

FIG. 9 includes an exemplary screenshot of the application displaying exemplary “My Picks” view information;

FIG. 10 includes an exemplary screenshot of the application displaying exemplary “Search by Artist” view information;

FIG. 11 includes an exemplary screenshot of the application displaying exemplary “Search by Keyword” view information;

FIG. 12 includes an exemplary screenshot of the application displaying exemplary “Buzzing Events” view information;

FIG. 13 includes an exemplary buzzing score calculation flowchart;

FIG. 14 includes an exemplary screenshot of the application displaying exemplary “friend recommendation” view information;

FIG. 15 includes an exemplary screenshot of the application displaying exemplary “Critic's Pick” view information;

FIG. 16 includes an exemplary screenshot of the application displaying exemplary “one event page” view information and artist tabs;

FIG. 17 includes an exemplary screenshot of the application displaying exemplary “one event page” view information and venue information;

FIG. 18a includes a table showing exemplary badge names and descriptions;

FIG. 18b includes an exemplary screenshot of the application displaying exemplary badges earned by the user;

FIG. 19 includes an exemplary screenshot of the application displaying exemplary badges earned by the user and badges available to be earned;

FIG. 20 includes an exemplary depiction of an exemplary advertisement associated with the application;

FIG. 21 includes an exemplary depiction of another exemplary advertisement associated with the application;

FIG. 22a includes an exemplary screenshot of the application displaying an exemplary promotion offered to a user of the application;

FIG. 22b includes an exemplary screenshot of the application displaying another exemplary promotion offered to a user of the application;

FIG. 23 includes an exemplary screenshot of the application displaying an exemplary locally branded version of the application;

FIG. 24 includes an exemplary screenshot of the application displaying an exemplary interactive promotional tool for capturing and sharing media;

FIG. 25 includes an exemplary screenshot of the application displaying an exemplary view of a promotion creation tool;

FIG. 26 includes an exemplary screenshot of the application displaying another exemplary view of a promotion creation tool;

FIG. 27 includes an exemplary screenshot of the application displaying an exemplary view of an add music listing tool; and

FIG. 28 includes an exemplary depiction of exemplary communication protocols and exemplary devices containing the application.

### DESCRIPTION

The following includes definitions of exemplary terms used throughout the disclosure. Both singular and plural forms of all terms fall within each meaning:

“Computer Readable Medium”, as used herein, includes but is not limited to any memory device, storage device, compact disc, floppy disk, or any other medium capable of storing data temporarily and/or permanently that can be interpreted by a computer.

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Signal”, as used herein, includes but is not limited to one or more electrical signals, analog or digital signals, one or more instructions, a bit or bit stream, or the like. The term “command” is synonymous with “signal.”

“Network”, as used herein, includes but is not limited to the Internet, intranets, Wide Area Networks (WANs), Local Area Networks (LANs), and transducer links such as those using Modulator-Demodulators (modems).

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Integrated Circuit” (“IC”), as used herein, includes, but is not limited to a small electronic device made out of a semiconductor material. Integrated circuits are used for a variety of devices, including microprocessors, audio and video equipment, and automobiles.

“Chip”, as used herein, includes but is not limited to a small piece of semiconducting material (usually silicon) on which an IC is embedded. Computing devices consist of many chips placed on electronic boards called printed circuit boards. Different types of chips include, for example, CPU chips (also called microprocessors), which contain an entire processing unit, and memory chips, which store data.

“Device”, as used herein, includes any machine or component that attaches to a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands.

“Address”, as used herein, includes but is not limited to one or more e-mail addresses, a distribution list including one or more e-mail addresses, uniform resource locator (URL) and file transfer protocol (FTP) locations or the like, network drive locations, a postal address, a combination of an e-mail address and a postal address, or other types of addresses that can identify a desired destination.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

“Kernel”, as used herein, includes but is not limited to a component of an operating system (OS) within a computing device. The kernel provides services that may be used by other parts of at least one of the OS, the hardware, and applications run by the computing device. For example, the kernel is typically responsible for at least one of memory management, process and task management, and disk management.

“Kernel Module”, as used herein, includes but is not limited to independent pieces of software that provide an interface between an OS included within a computing device and other devices that communicate with the OS (e.g., at least one of the hardware and peripheral devices). Generally speaking, a kernel module is a section of software in the kernel responsible for supporting a specific feature or capability. For example, file system types and device drivers are kernel modules.

“Command Line Interpreter” (CLI), as used herein, includes but is not limited to an interface between a user and the kernel. The CLI, also referred to as a “shell,” interprets commands entered by, for example, a user and arranges for the commands to be executed by, for example, a CPU.

In one embodiment, the present system and method provide the capability of optimizing communication about entertainment. For example, entertainment may include music (including live or recorded), plays, films, shows, acts, productions, or any other performances. In one embodiment, communication and awareness associated with live music is optimized. In particular, an exemplary application, also referred to as “GETn2it” or “in2une,” can be utilized to optimize communication and awareness of live music events for a particular market.

As illustrated, blocks represent logic functions, actions and/or events performed therein. It will be appreciated that electronic and software systems involve dynamic and flexible processes such that the illustrated blocks and described sequences can be performed in different sequences or in parallel. It will also be appreciated by one of ordinary skill in the art that elements embodied as software may be implemented using various programming approaches such as machine language, procedural, object-oriented, or artificial intelligence techniques. It will further be appreciated that, if desired and appropriate, some or all of the software can be embodied as part of a device's operating system.

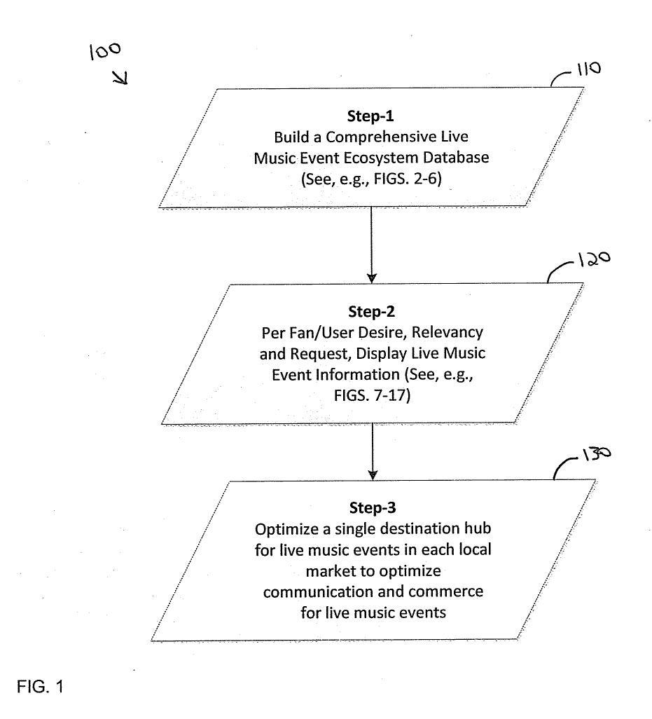

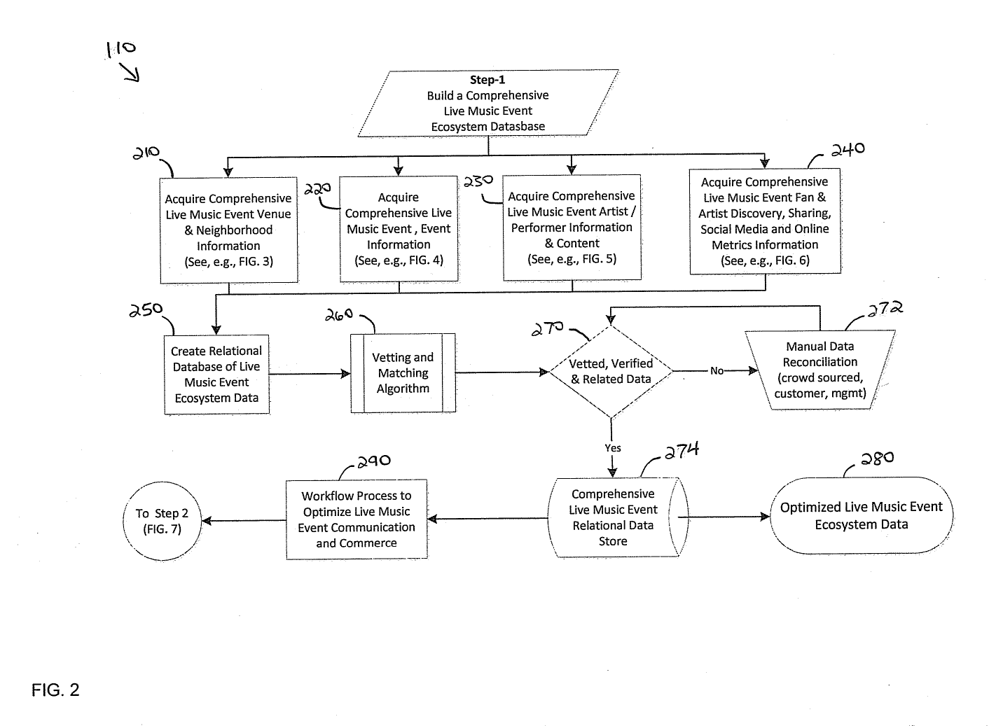

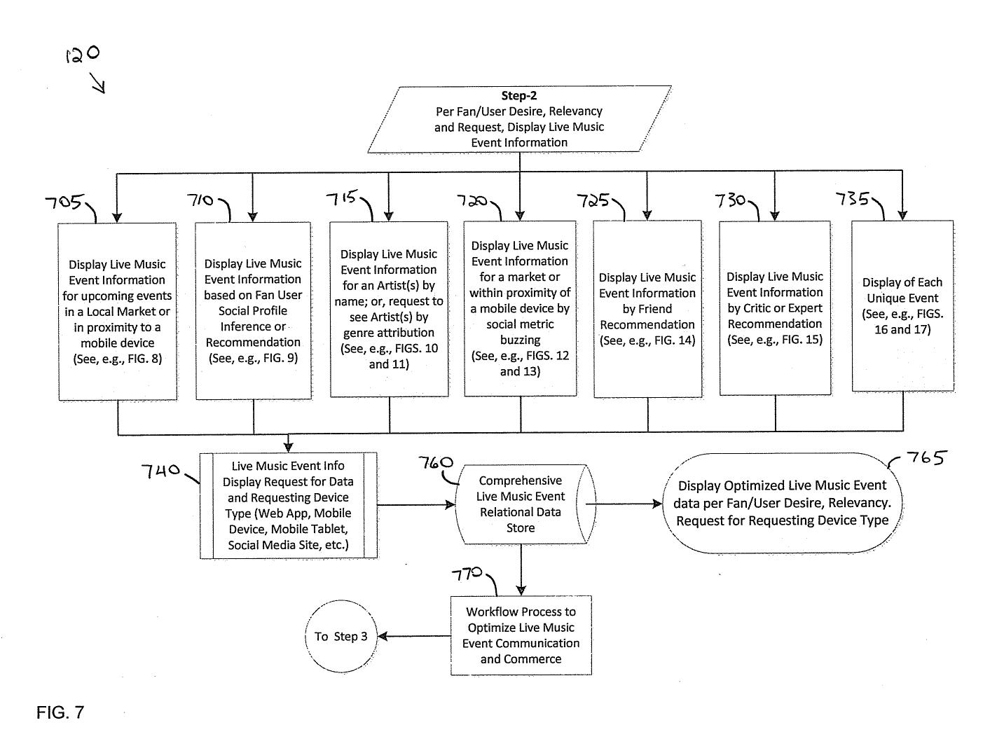

With reference to FIG. 1, a simplified, high-level flowchart 100 shows exemplary steps associated with optimizing communication and awareness of live music for a particular market. These steps may be implemented via an application, such as, e.g., GETn2it. In block 110, a comprehensive live music event ecosystem database may be built. The details associated with block 110 will be described in more detail below in association with FIGS. 2-6. Following block 110, block 120 allows for the customized display of live music event information, e.g., based on factors such as fan/user desires, relevancy, and requests. The details associated with block 120 will be described in more detail below in association with FIGS. 7-17. Following block 120, block 130 can optimize a single destination hub for live music events in a particular local market. A hub may be, e.g., a local concert database or local concert calendar. When optimized, the hub can improve communication and commerce associated with the live music events included in the hub. In other embodiments, as described below, a local market can take advantage of a single comprehensive live music event hub and ecosystem workflow to optimize acquisition and display of event, venue, artist, recommendation, general social media activity, and the social media and in-application activity of a user's friends in and around live music events.

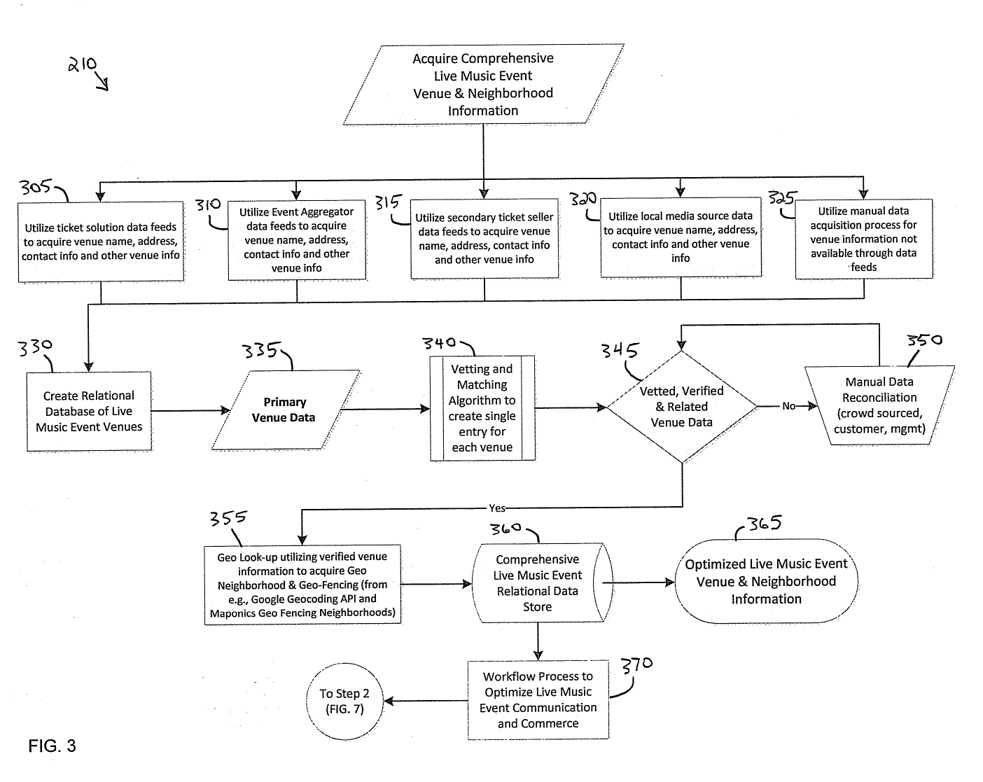

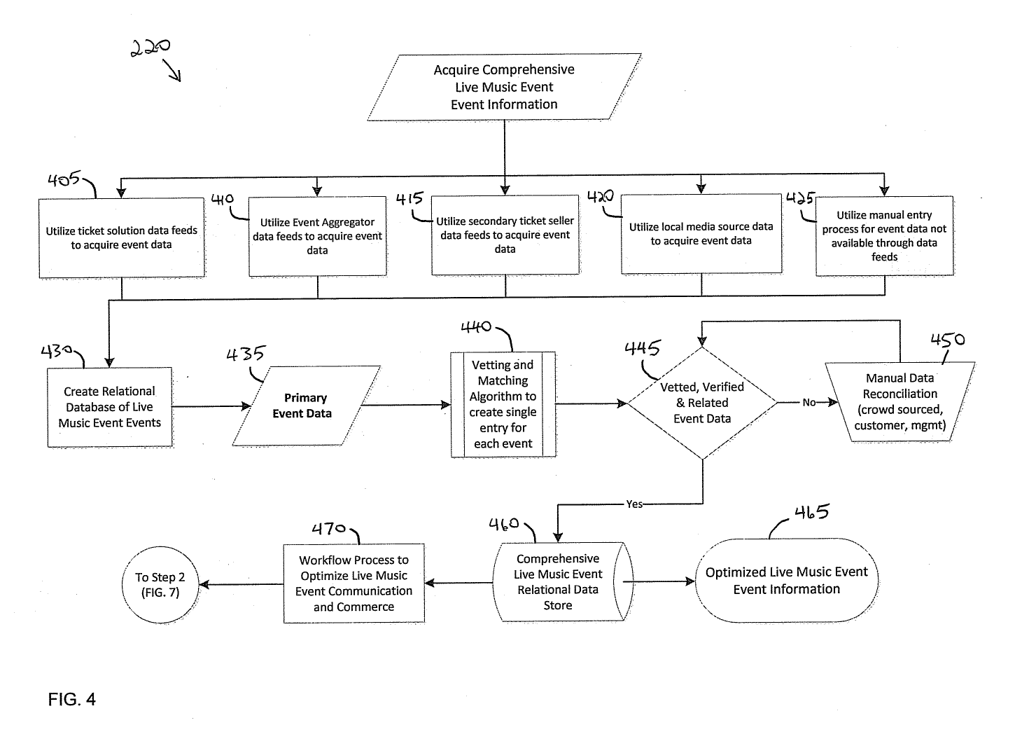

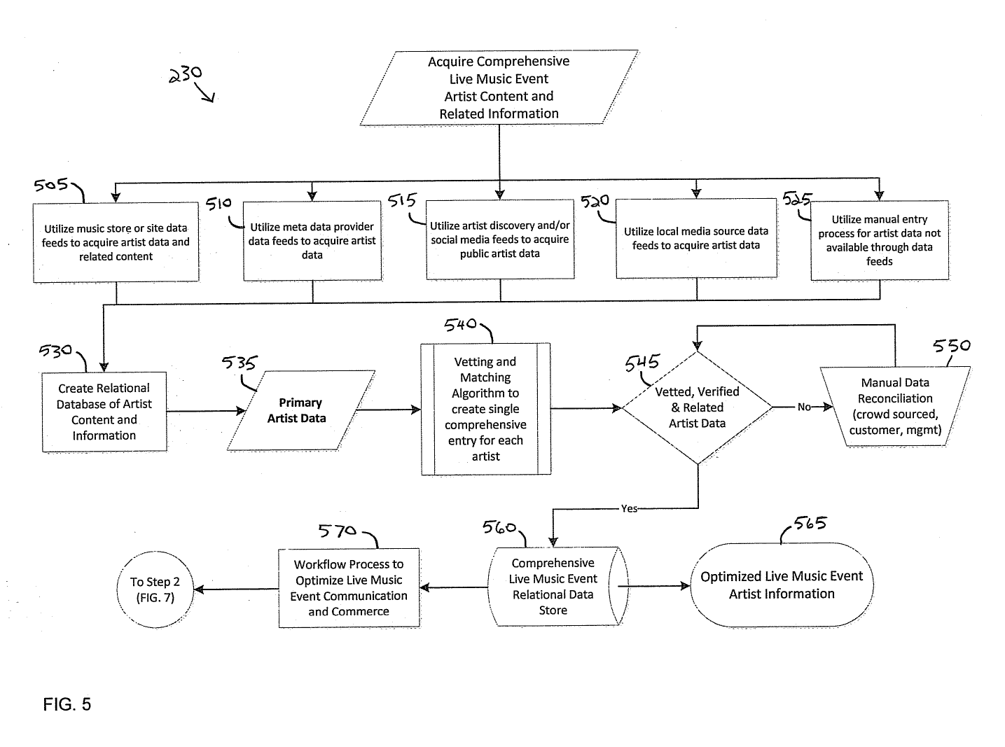

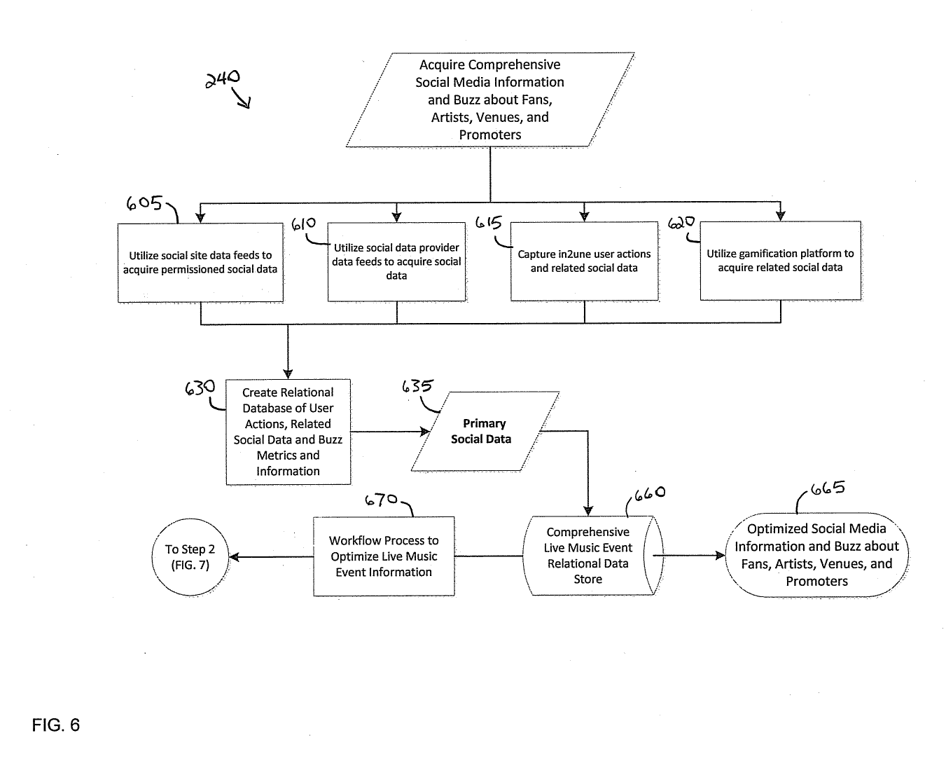

With reference to FIG. 2, a flowchart is illustrated in accordance with an exemplary embodiment of step 1 (block 110), showing exemplary steps associated with building a comprehensive live music event ecosystem database. At block 210, the exemplary application can acquire comprehensive live music event venue and neighborhood information. Exemplary details associated with block 210 will be described in more detail below in association with FIG. 3. At block 220, the exemplary application can acquire comprehensive live music event “event” information. Exemplary details associated with block 220 will be described in more detail below in association with FIG. 4. At block 230, the exemplary application can acquire comprehensive live music event artist/performer information and content. Exemplary details associated with block 230 will be described in more detail below in association with FIG. 5. At block 240, the exemplary application can acquire comprehensive live music event fan and artist discovery, sharing, social media, and online metrics information. Exemplary details associated with block 240 will be described in more detail below in association with FIG. 6.

With continued reference to FIG. 2, after blocks 210-240, the application can create a relational database of live music event ecosystem data in block 250, based on all of the information acquired in blocks 210-240. At block 260, the application can execute a vetting and matching algorithm to compare potentially related, overlapping, or conflicting data in the relational database. At block 270, the application determines whether the data in the relational database is properly vetted, verified, and related. If the data is not, the application proceeds to block 272, where the data may be manually reconciled by, e.g., crowd sourcing, application users, and/or application management. After block 272, the data is rechecked in block 270. This loop may continue until the data is determined to be properly vetted, verified, and related. Next, the application proceeds to block 274, where the comprehensive live music event relational data is stored. In block 280, this data store flows into the optimized live music event ecosystem data. In addition, in block 290, this data store flows into further steps associated with optimizing live music event communication and commerce, as shown below in association with FIG. 7.

With reference to FIG. 3, a flowchart is illustrated in accordance with an exemplary embodiment of block 210, showing exemplary steps associated with acquiring comprehensive live music event venue and neighborhood information. At block 305, the exemplary application can utilize ticket solution data feeds to acquire venue name, address, contact information, and other venue information. This step and other steps may be accomplished automatically via programmatic means. For example, live music event venues and promoters may utilize primary ticket solution providers to sell tickets to their events (e.g., Ticketmaster). Primary ticket solutions may provide data export feeds and application programming interfaces (APIs) as a means for other companies to use the event data to further market events and sell their tickets. In this manner, the application may utilize these ticket solution data feeds to acquire the associated information.

At block 310, the exemplary application can utilize event aggregator data feeds to acquire venue name, address, contact information, and other venue information. For example, event aggregators may create databases of live music event information (e.g., Eventful). Included events may include ticketed and non-ticketed events. These event aggregators may sell access to their databases through event feed APIs. In this manner, the application may utilize these event aggregator data feeds to acquire the associated information.

At block 315, the exemplary application can utilize secondary ticket seller data feeds to acquire venue name, address, contact information, and other venue information. For example, secondary ticket sellers may exist in the marketplace and facilitate a secondary market for buying selling tickets to live music events (e.g., TicketsNow). This buying and selling may be between fans. These secondary ticket sellers may sell access to their databases through event feed APIs. In this manner, the application may utilize these secondary ticket seller data feeds to acquire the associated information.

At block 320, the exemplary application can utilize local media source data to acquire venue name, address, contact information, and other venue information. For example, the local market media may cover and report on live music (e.g., the alternative newsweekly the Nashville Scene covers music events in Nashville, Tenn.) and may provide venue listings in their print publication and websites. Venue information may be available as a data feed from the local media source or a research source. In this manner, the application may utilize local media source data to acquire the associated information.

At block 325, the exemplary application can utilize a manual data acquisition process to acquire venue name, address, contact information, and other venue information. For venue information not available from programmatic data feeds, one or more manual data acquisition processes may be utilized. For example, the application may use: (1) a simple web-based tool, application, or form for entering venue information via “crowdsourcing;” or (2) Event Synch, a web application available for artists, venues, and promoters to manually enter their venue and concert calendar information. In this manner, the application may utilize a manual data acquisition process to acquire the associated information. FIG. 27 includes an exemplary screenshot 2700 of the application displaying the fields of an exemplary manual data acquisition process, e.g., an add live music listing tool.

With continued reference to FIG. 3, after blocks 305-325, the application can create a relational database of live music event venues in block 330, based on all of the information acquired in blocks 305-325. Proceeding to block 335, the relational database of live music event venues yields the primary venue data. Primary venue data can include, e.g., venue name, alias, address, city/state/zip code/country code, phone number, email, website, social media sites, geographic latitude/longitude, geographic neighborhood, ticket solution and ID, and any other primary or secondary data.

At block 340, the application can execute a vetting and matching algorithm to create a single entry for each venue in the relational database. At block 345, the application determines whether the venue data in the relational database is properly vetted, verified, and related. If the data is not, the application proceeds to block 350, where the data may be manually reconciled by, e.g., crowd sourcing, application users, and/or application management. After block 350, the data is rechecked in block 345. This loop may continue until the data is determined to be properly vetted, verified, and related. The application then proceeds to block 355, where the application can execute a geo (geographical) look-up utilizing verified venue information to acquire geo-neighborhood and geo-fencing (from, e.g., Google Geocoding API and Maponics Geo Fencing Neighborhoods).

Next, the application proceeds to block 360, where the venue data is stored in the comprehensive live music event relational data store. After block 360, in block 365, the live music event venue and neighborhood information is optimized. As shown in block 370, this data store flows into further steps associated with optimizing live music event communication and commerce, as shown below in association with FIG. 7.

With reference to FIG. 4, a flowchart is illustrated in accordance with an exemplary embodiment of block 220, showing exemplary steps associated with acquiring comprehensive live music event “event” information. At block 405, the exemplary application can utilize ticket solution data feeds to acquire event data. This step and other steps may be accomplished automatically via programmatic means. For example, live music event venues and promoters may utilize primary ticket solution providers to sell tickets to their events (e.g., Ticketmaster). Primary ticket solutions may provide data export feeds and APIs as a means for other companies to use the event data to further market events and sell their tickets. In this manner, the application may utilize these ticket solution data feeds to acquire the associated information.

At block 410, the exemplary application can utilize event aggregator data feeds to acquire event data. For example, event aggregators may create databases of live music event information (e.g., Eventful). Included events may include ticketed and non-ticketed events. These event aggregators may sell access to their databases through event feed APIs. In this manner, the application may utilize these event aggregator data feeds to acquire the associated information.

At block 415, the exemplary application can utilize secondary ticket seller data feeds to acquire event data. For example, secondary ticket sellers may exist in the marketplace and facilitate a secondary market for buying selling tickets to live music events (e.g., TicketsNow). This buying and selling may be between fans. These secondary ticket sellers may sell access to their databases through event feed APIs. In this manner, the application may utilize these secondary ticket seller data feeds to acquire the associated information.

At block 420, the exemplary application can utilize local media source data to acquire event data. For example, the local market media may cover and report on live music (e.g., the alternative newsweekly the Nashville Scene covers music events in Nashville, Tenn.) and may provide event listings in their print publication and websites. Event data may be available as a data feed from the local media source or a research source. In this manner, the application may utilize local media source data to acquire the associated information.

At block 425, the exemplary application can utilize a manual data acquisition process to acquire venue name, address, contact information, and other venue information. For event information not available from programmatic data feeds, one or more manual data acquisition processes may be utilized. For example, the application may use: (1) a simple web-based tool, application, or form for entering event information via “crowdsourcing;” or (2) Event Synch, a web application available for artists, venues, and promoters to manually enter their venue and concert calendar information. In this manner, the application may utilize a manual data acquisition process to acquire the associated information.

With continued reference to FIG. 4, after blocks 405-425, the application can create a relational database of live music event “events” in block 430, based on all of the information acquired in blocks 405-425. Proceeding to block 435, the relational database of live music event “events” yields the primary event data. Primary event data can include, e.g., event date, event artist headliner, event artist supporting artists, event venue info, ticket cost, ticket purchase URL, and any other primary or secondary data.

At block 440, the application can execute a vetting and matching algorithm to create a single entry for each event in the relational database. At block 445, the application determines whether the event data in the relational database is properly vetted, verified, and related. If the data is not, the application proceeds to block 450, where the data may be manually reconciled by, e.g., crowd sourcing, application users, and/or application management. After block 450, the data is rechecked in block 445. This loop may continue until the data is determined to be properly vetted, verified, and related. Next, the application proceeds to block 460, where the event data is stored in the comprehensive live music event relational data store. After block 460, in block 465, the live music event “event” information is optimized. As shown in block 470, this data store flows into further steps associated with optimizing live music event communication and commerce, as shown below in association with FIG. 7.

With reference to FIG. 5, a flowchart is illustrated in accordance with an exemplary embodiment of block 230, showing exemplary steps associated with acquiring comprehensive live music event artist content and related information. At block 505, the exemplary application can utilize music store or site data feeds to acquire artist data and, if available, related content. This step and other steps may be accomplished automatically via programmatic means. For example, artists may provide or sell their content (e.g., audio, video, merchandise, concert tickets, etc.) via music stores or sites (e.g., iTunes, Soundcloud, Ticketmaster, venue and artist websites, etc.). For promotional purposes, music stores, sites, and artists may provide authorized companies with the ability to use artist content to market and promote the artist and/or sell their content. In this manner, the application may utilize these music store or site data feeds to acquire the associated information.

At block 510, the exemplary application can utilize metadata provider data feeds to acquire artist data. For example, artist metadata providers (e.g., All Music Guide, Echonest, MusicBrainz, Next Big Sound, Music Stores, etc.) may create databases of artist information (e.g., artist name, aliases, albums, tracks, social media sites, social media metrics, social media buzz, etc.). These metadata providers may provide free access or sell access to their databases through data APIs. In this manner, the application may utilize these metadata provider data feeds to acquire the associated information.

At block 515, the exemplary application can utilize artist discovery and/or social media feeds to acquire public artist data and, if available, content. For example, artists may use social media and discovery sites (e.g., Facebook, Youtube, Vimeo, Soundcloud, MySpace, Twitter, etc.) to generate awareness about themselves, enable fans to view video, hear audio, interact with other fans, and disseminate information about the band (such as, e.g., concert dates). These discovery and social media sites may maintain public information available to anyone on the Internet. This public information may be available via a data feed or an API. In this manner, the application may utilize these social media feeds to acquire the associated information.

At block 520, the exemplary application can utilize local media source data to acquire artist data. For example, the local market media may cover and report on live music (e.g., the alternative newsweekly, the Nashville Scene covers music events in Nashville, Tenn.) and may provide artist information in their print publication and websites. Artist information may be available as a data feed from the local media source or a research source. In this manner, the application may utilize local media source data to acquire the associated information.

At block 525, the exemplary application can utilize a manual data acquisition process to acquire artist information. For artist information not available from programmatic data feeds, one or more manual data acquisition processes may be utilized. For example, the application may use: (1) a simple web-based tool, application, or form for entering artist information via “crowdsourcing;” or (2) a web application available for artists, venues, and promoters to manually enter their event data, concert calendar, and artist information. In this manner, the application may utilize a manual data acquisition process to acquire the associated information.

With continued reference to FIG. 5, after blocks 505-525, the application can create a relational database of artist content and information in block 530, based on all of the information acquired in blocks 505-525. Proceeding to block 535, the relational database of artist content and information yields the primary artist data. Primary artist data can include, e.g., artist name, aliases, audio/video catalog, preview tracks, links to sites where content or merchandise may be purchased, social media sites, discovery sites, artist images, artist bio, artist concert dates, and any other primary or secondary data concerning the artist.

At block 540, the application can execute a vetting and matching algorithm to create a single comprehensive entry for each artist in the relational database. At block 545, the application determines whether the artist data in the relational database is properly vetted, verified, and related. If the data is not, the application proceeds to block 550, where the data may be manually reconciled by, e.g., crowd sourcing, application users, and/or application management. After block 450, the data is rechecked in block 545. This loop may continue until the data is determined to be properly vetted, verified, and related. Next, the application proceeds to block 560, where the artist data is stored in the comprehensive live music event relational data store. After block 560, in block 565, the live music event artist information is optimized. As shown in block 570, this data store flows into further steps associated with optimizing live music event communication and commerce, as shown below in association with FIG. 7.

With reference to FIG. 6, a flowchart is illustrated in accordance with an exemplary embodiment of block 240, showing exemplary steps associated with acquiring comprehensive social media information and buzz about fans, artists, venues, and promoters. At block 605, the exemplary application can utilize social site data feeds to acquire social profile data to the extent permitted by the user or social media platform. This step and other steps may be accomplished automatically via programmatic means. For example, the application can allow users to register and login to the GETn2it or in2une application with their social media identities (e.g., Google, Facebook, Twitter) and collect their permission-based social data. Detailed user social information may be captured, such as, e.g., demographics, interests, likes, music, activities, and social connections (friends), as well as aggregate social metrics (number of new fans this week, number of audio or video plays, etc.). In this manner, the application may utilize these social site data feeds to acquire the associated information.

At block 610, the exemplary application can utilize social data provider data feeds to acquire social data. For example, the application may gather social media, peer-to-peer and web buzz, metrics from online companies (such as, e.g., Echonest, Next Big Sound, MusicMetric, etc.) to aggregate music related metrics and buzz information about artists and from websites mentioning an artist or release or concert, and the social networks frequented by music fans and artists. In this manner, the application may utilize these social data provider data feeds to acquire the associated information.

At block 615, the exemplary application can capture user actions and related social data within the application (e.g., GETn2it, in2une). For example, the application can gather user action and social data about live music event sharing (e.g., to which friends and which social media sites events have been shared), audio plays, comments made (e.g., the action taken and the sentiment expressed), video views, followers gained, when fans refer an event to friends, friend referral actions, purchases (e.g., tickets, tracks), etc. In this manner, the application may utilize these user actions and related social data within the application to acquire the associated information.

At block 620, the exemplary application can utilize the application's “gamification” platform to acquire related social data. For example, certain specific user actions, when identified and recognized, can contribute to positive business outcomes. To take advantage of this, a “gamification” platform can be implemented to track users for certain activities, such as, e.g., audio plays, video plays, shares of events with friends, comments about events, creating and sharing My Picks calendars, the acquisition of followers, and commenting by others. For users who share their My Picks calendars, additional referral user actions can be tracked for establishing influencer clout (e.g., a fan shares and then their “share-ees” click any of the above user actions). The gamification platform can be a programmatic tool to identify more influential live music fans and users of the application. Additional usage may include providing gifts to influencers and/or providing deals, promos, artist meet-and-greets, and campaigns by artists, venues, and brands, etc. Gamification is described in further detail below. In this manner, the application may utilize the gamification platform to acquire the associated information.

With continued reference to FIG. 6, after blocks 605-620, the application can create a relational database of user actions, related social data, and buzz metrics and information in block 630, based on all of the information acquired in blocks 605-620. Proceeding to block 635, the relational database of user actions, related social data, and buzz metrics and information yields the primary social data. Primary social data can include, e.g.: venue, artist, promoter, and fan permissioned social login to (GETn2it) application; related social data and user actions; and any other primary or secondary social data and buzz metrics.

Next, the application proceeds to block 660, where the social data is stored in the comprehensive live music event relational data store. After block 660, in block 665, the social media information and buzz about fans, artists, venues, and promoters is optimized. As shown in block 670, this data store flows into further steps associated with optimizing live music event communication and commerce, as shown below in association with FIG. 7.

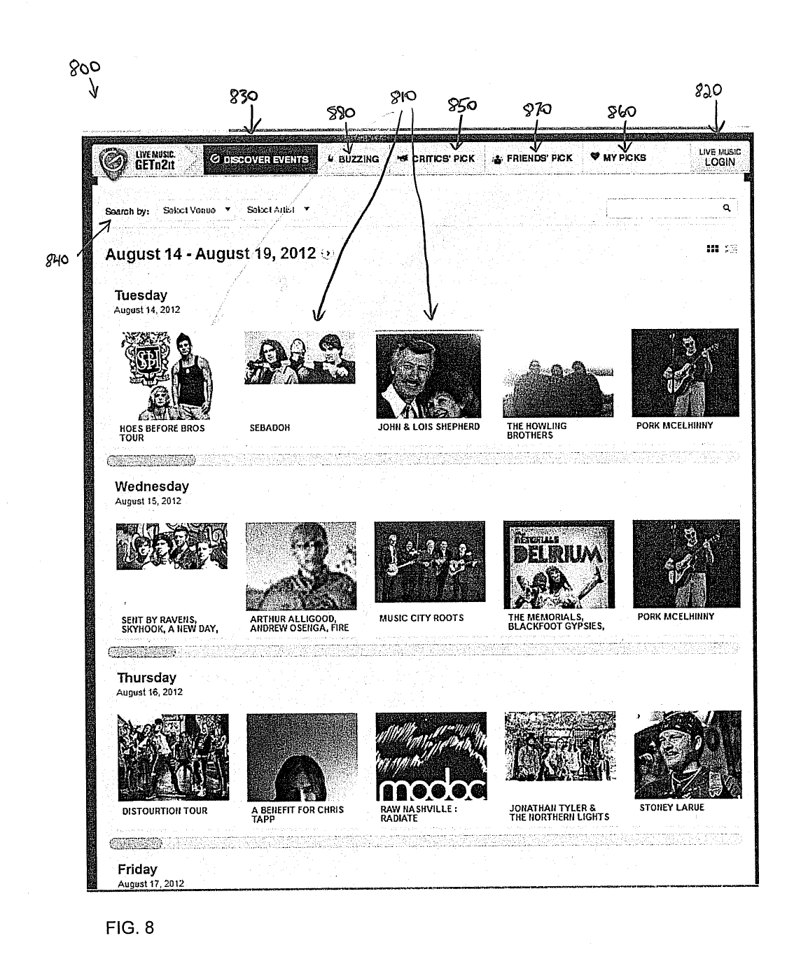

With reference to FIG. 7, a flowchart is illustrated showing exemplary steps associated with displaying exemplary live music event information, e.g., based on fan/user desire, relevancy, and request. At block 705, the exemplary application can display live music event information for upcoming events in a local market or in proximity to a mobile device (e.g., events within a 25-mile radius of a mobile phone, mobile tablet, etc.) with the ability to request or refine the view of events by neighborhood. An exemplary screenshot of the application displaying event information in accordance with block 705 will be described in more detail below in association with FIG. 8.

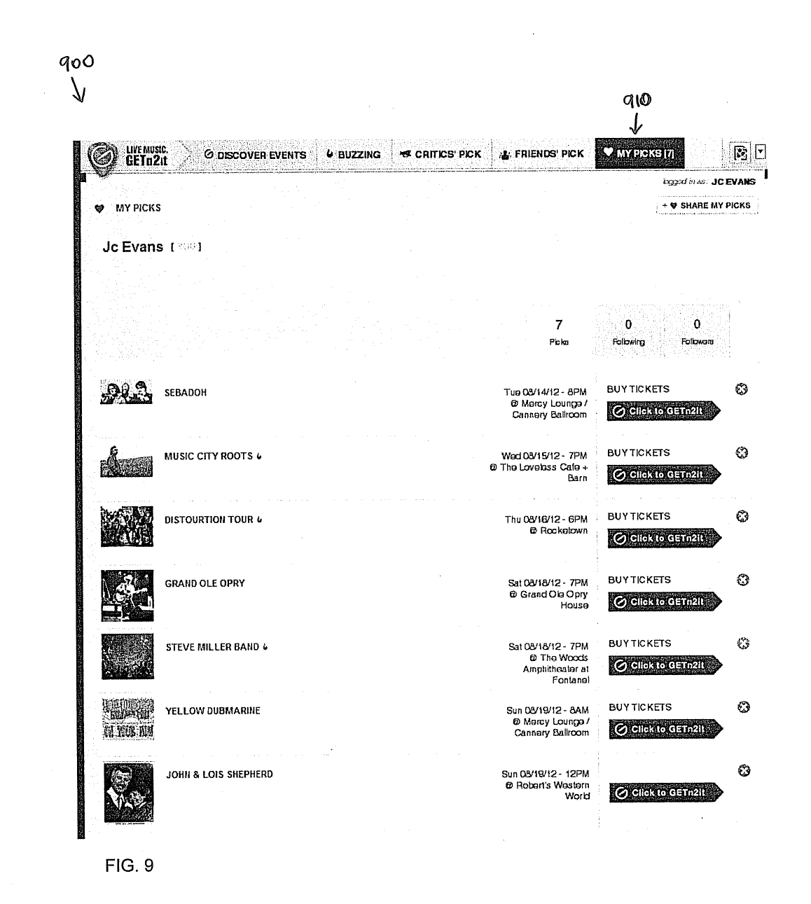

At block 710, the exemplary application can display live music event information based on fan user social profile inference or recommendation (e.g., artist and music likes, purchased music, friends, inferences, etc.). An exemplary screenshot of the application displaying event information in accordance with block 710 will be described in more detail below in association with FIG. 9.

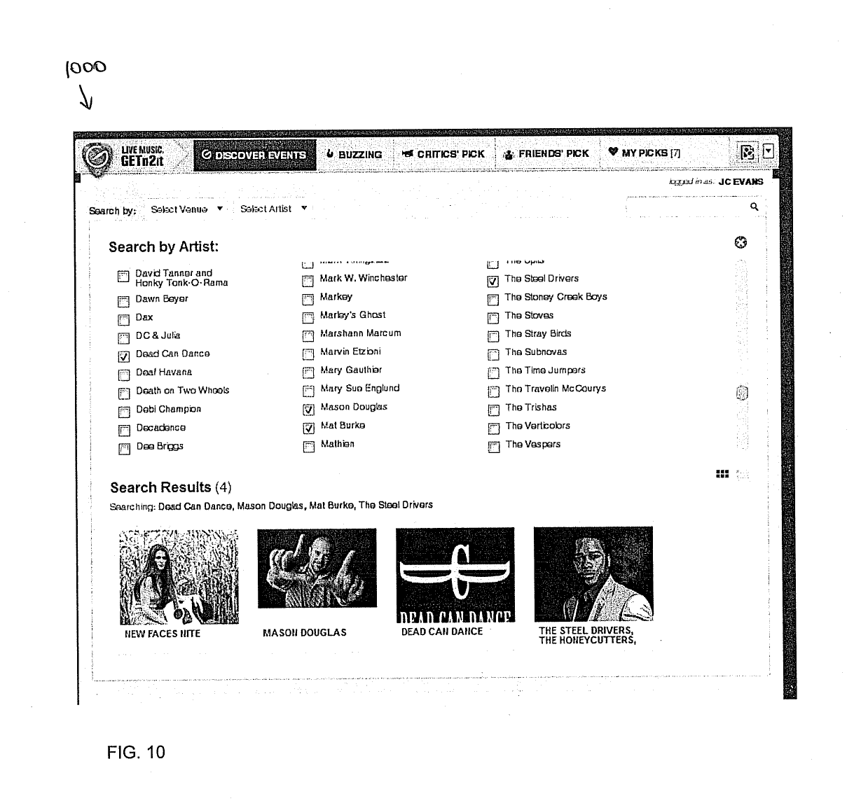

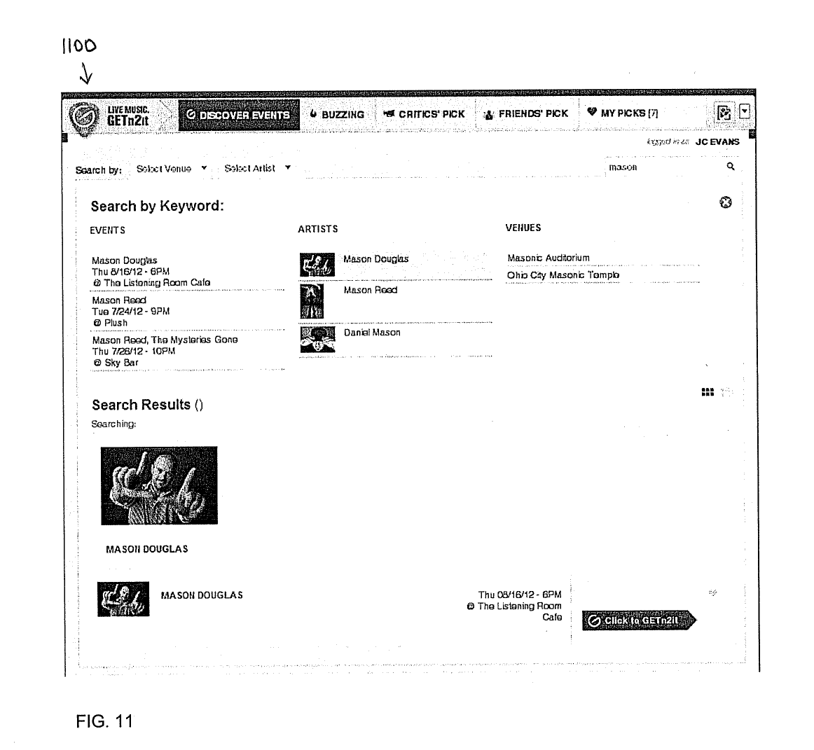

At block 715, the exemplary application can display live music event information for an artist(s) by name or request to see artist(s) by genre attribution. Exemplary screenshots of the application displaying event information in accordance with block 715 will be described in more detail below in association with FIGS. 10 and 11.

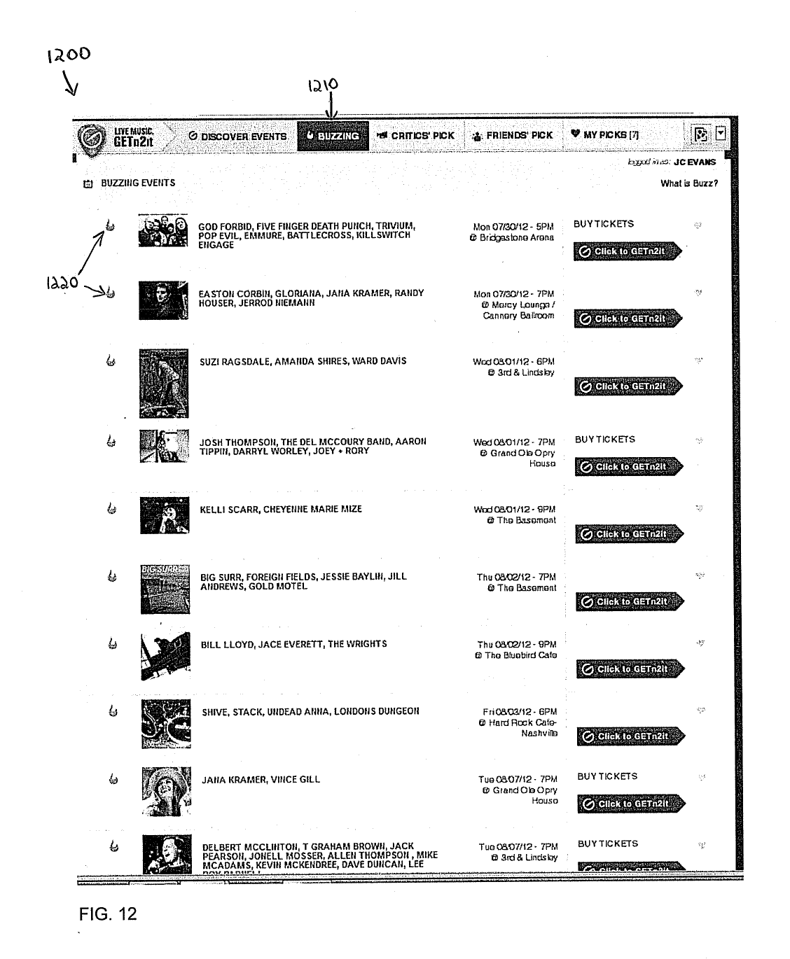

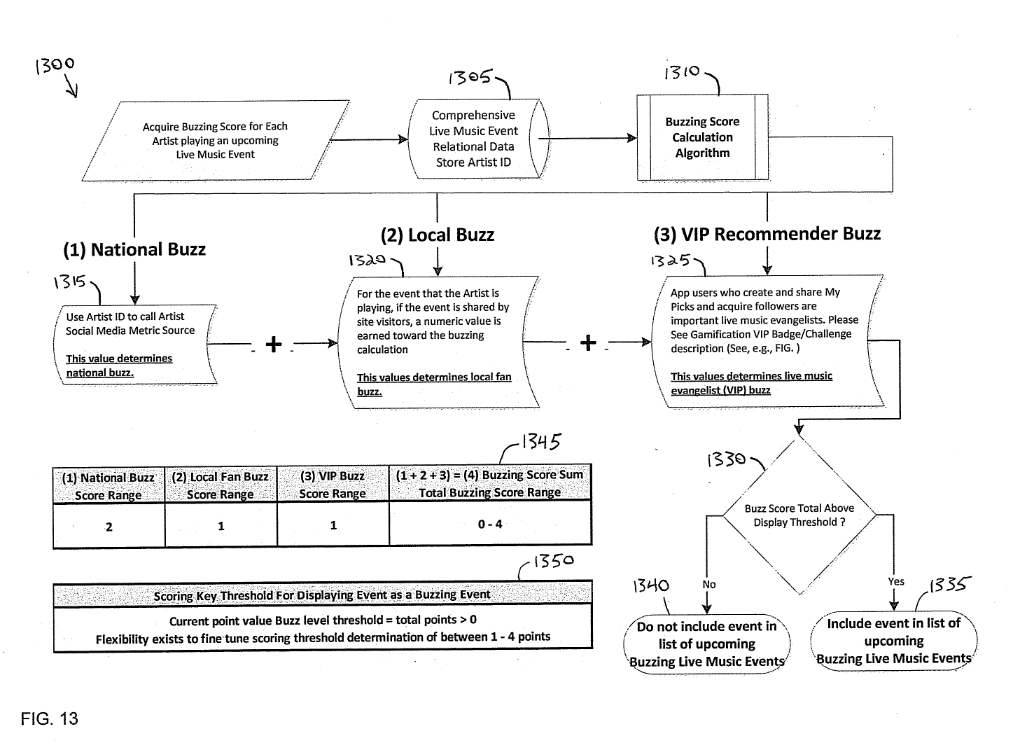

At block 720, the exemplary application can display live music event information for a market or within proximity of a mobile device by social metric buzzing. An exemplary screenshot of the application displaying event information and an exemplary buzzing score calculation in accordance with block 720 will be described in more detail below in association with FIGS. 12 and 13.

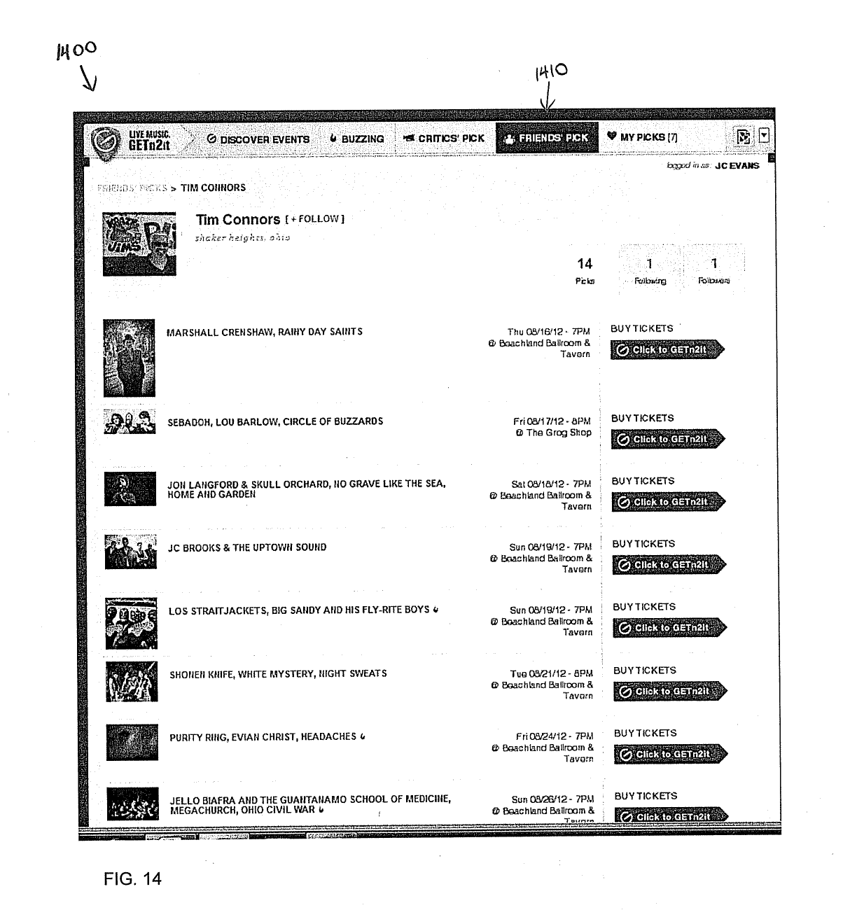

At block 725, the exemplary application can display live music event information, e.g., by friend recommendation as a single one-time view or by reoccurrence as an outcome of following the friend and their live music event recommendations. An exemplary screenshot of the application displaying event information in accordance with block 725 will be described in more detail below in association with FIG. 14.

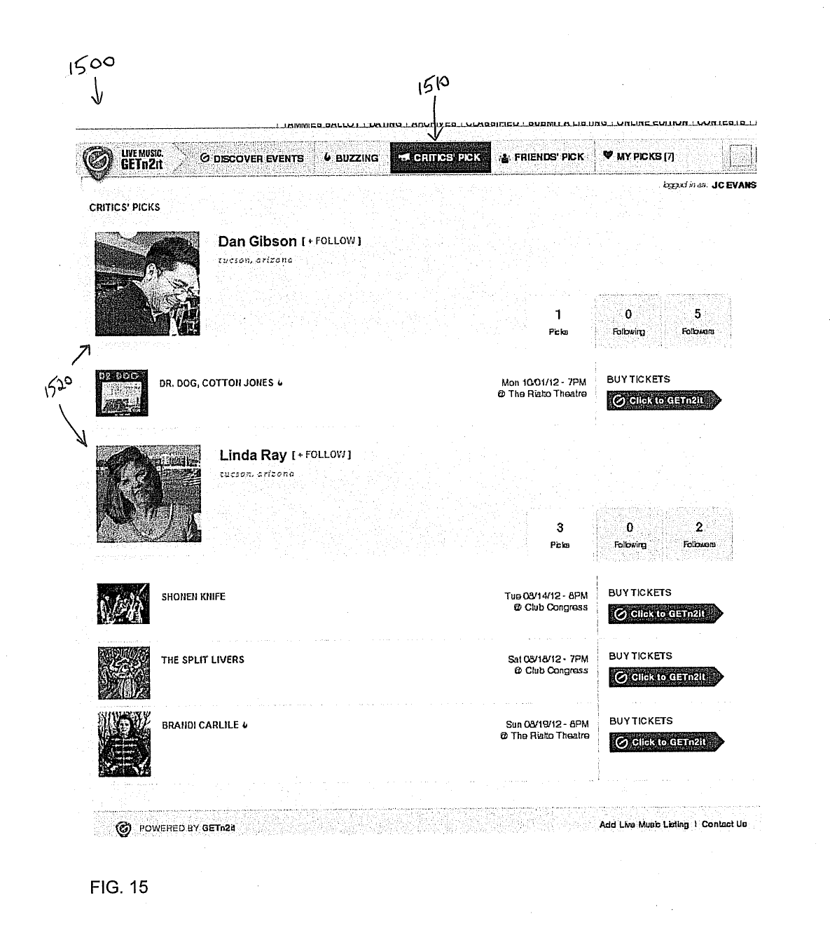

At block 730, the exemplary application can display live music event information, e.g., by critic or expert recommendation as a result of editorial point of view for media (e.g., Music “Editor Picks” for a local market publication, such as, Nashville Scene coverage of Nashville live music market). An exemplary screenshot of the application displaying event information in accordance with block 730 will be described in more detail below in association with FIG. 15.

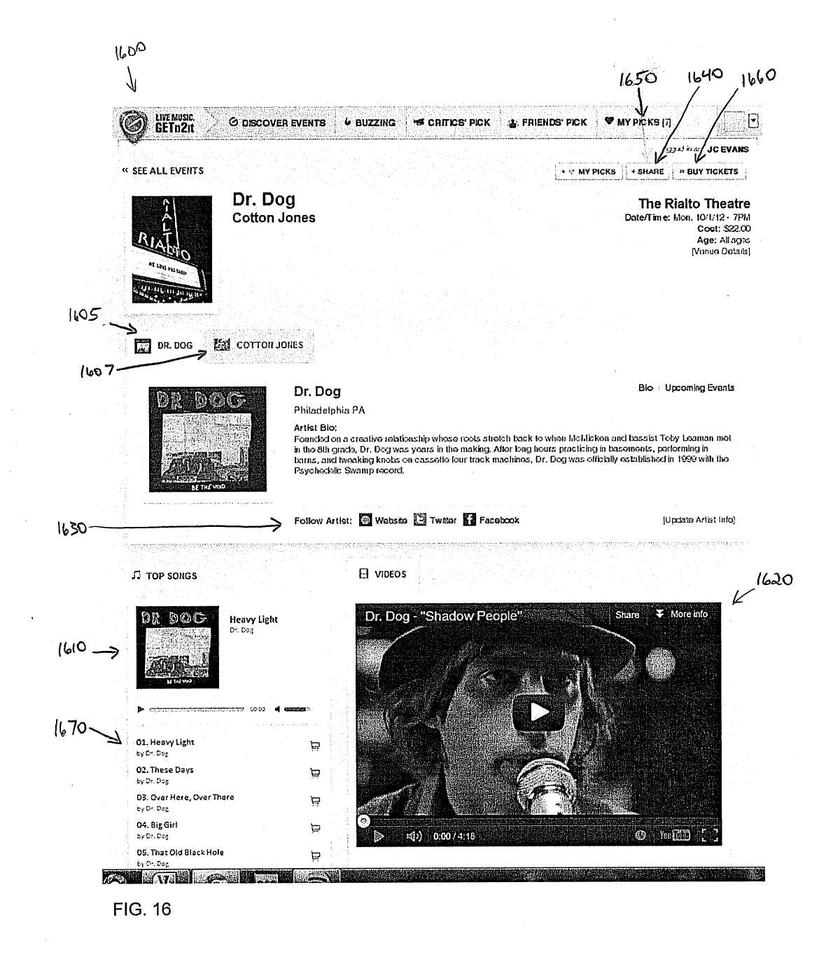

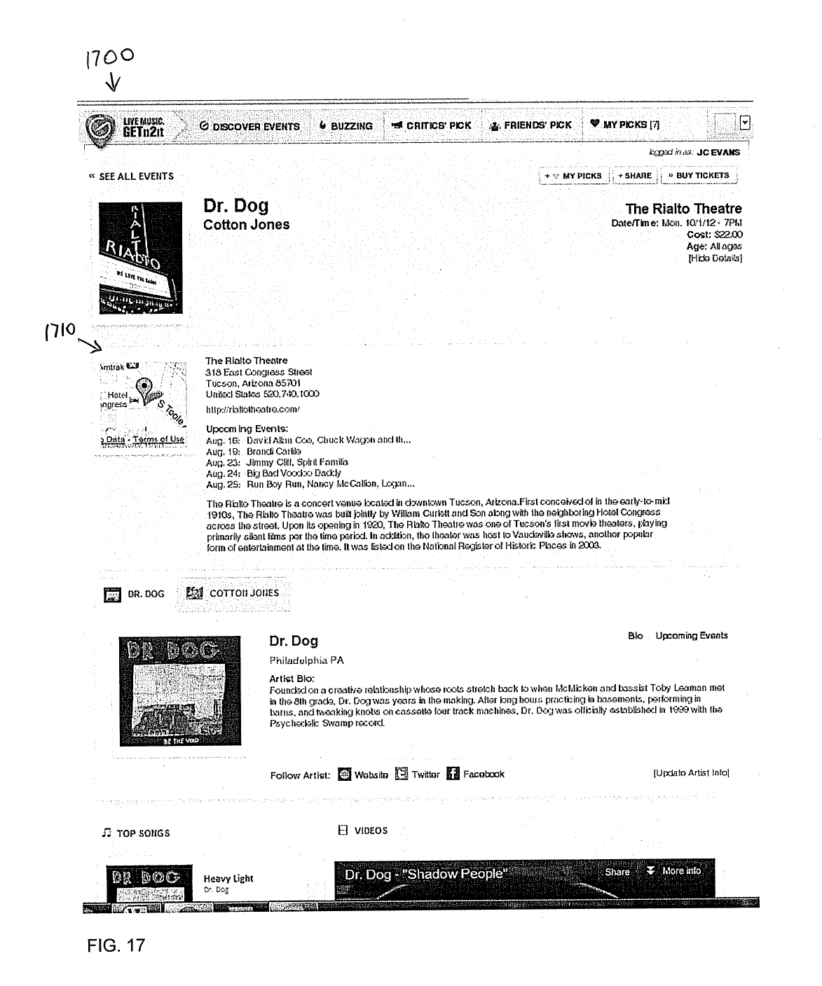

At block 735, the exemplary application can display each unique event. Each individual event may include, e.g., the following data to display about the event: hosting venue, date of event, ticket purchase information, headlining artist, supporting artist(s), audio and video content, social media sites, promoter, images, biography, etc. This may be referred to as the discovery, awareness, sharing and purchase page about the event. Exemplary screenshots of the application displaying event information in accordance with block 735 will be described in more detail below in association with FIGS. 16 and 17.

At block 740, the application can execute a live music event info display request for data and request device type (e.g., web application, mobile device, mobile tablet, social media site, etc.). Next, the application proceeds to block 760, where the requested data is retrieved from the comprehensive live music event relational data store. After block 760, in block 765, the application displays the optimized live music event data per fan/user desire, relevancy, and request, for the requesting device type. As shown in block 770, the data store can flow into step 3 (block 130) to support optimizing a single destination hub for live music events in each local market to optimize communication and commerce for live music events, as discussed in more detail below.

FIG. 8 includes an exemplary screenshot 800 of the application displaying exemplary “Discover Events” view information. This view, along with the other views, can display live music event information for upcoming events in a local market or in proximity to a mobile device (e.g., events within a 25-mile radius of a mobile phone, mobile tablet, etc.) with the ability to request or refine view of events by neighborhood. Clicking an event image 810 will present the site user with the event page (see, e.g., FIG. 16).

The application (e.g., GETn2it) can display a social concert calendar (e.g., 800) that includes a local live music calendar with rich media event discovery, commenting, friend picks, sharing, followers and following, publication curation and recommendation, and deep social media integration. The GETn2it social concert calendar 800 can embed on websites (e.g., local market media such as alternative newsweekly publications that cover local live music scenes) and can be available via mobile device and via social media sites. The exemplary screenshot 800 shows exemplary live music events for the Nashville local market. The headers and associated information are described generally below:

Live Music Login 820

GETn2it Login 820 enables application users to authenticate using their existing social network credentials from social media providers such as Facebook, Twitter, Google, etc. making sharing live music events easy across all social media. As users share events, content can be spread throughout each users' existing social network by leveraging friend-of-friend reach. The authentication allows permission based access to the fan's social profile data.

Discover Events 830 (Highlighted View in Screenshot 800)

The calendar can display an upcoming comprehensive list of events by Listview and Gridview. Rotating images scroll through headliner and supporting artists. The application can further refine a search using Search by (840) artist, genre, venue, date and open text. Clicking on an event image 810 will open the event page and artists playing. Other options may include: Listen to audio; View video; Share with friends; See reviews; Comment; Add to My Picks; Buy Tickets; and Audio Tracks.

Critics Pick 850

The official curated and recommended selection of live music events by other media outlets, e.g., the local market publication. Editors, Writers, Bloggers for the publication can create a My Picks list (description below), edit event and artist info and provide a Critic Pick Comment.

My Picks 860

The concert calendar user can socially login and click a heart to pick any event. The user has a My Picks page where their selected picks are viewable, which the user can access using My Picks button 860. Users can comment on shows and share their picks across social media with their friends. Users can gain and grow followers (e.g., like Twitter for Live Music). To incent and recognize engagement activities, the game mechanics design can be used to create a status recognition badge program, described in detail below. The badges are displayed on the user's My Picks page.

Friends Pick 870

The Friends Pick 870 is a listing of users who have created My Picks 860. The top of this page can display Featured Tastemakers. The publication may be encouraged to identify Tastemakers (a music editor, writer, columnist) and have them create picks, gain followers, and extend the reach of the publication through the connected social media.

Buzzing Events 880

The upcoming events listed on the Buzzing Events page are prioritized according to a ranking algorithm. The Buzz ranking is described in detail below.

Add Live Music Listing and Update Artist Info (not shown)

Online forms may be provided to get live music event information to the application's data team to be vetted. Another application, e.g., Event Synch, can add additional functionality for venues, artists, and promoters to add, maintain, and update their upcoming live music event information.

FIG. 9 includes an exemplary screenshot 900 of the application displaying exemplary “My Picks” view information.

My Picks 910

The user can discover live music events by date, venue, artist, week, genre, friend recommendation, Critic Pick, Buzzing Events, etc. and create their own My Picks 910 Calendar by clicking the event “heart” or “add event to My Picks” button. The user has a My Picks page 900 where their selected picks are viewable. Users can comment on their shows and share their picks across social media with their friends.

FIG. 10 includes an exemplary screenshot 1000 of the application displaying exemplary “Search by Artist” view information. FIG. 11 includes an exemplary screenshot 1100 of the application displaying exemplary “Search by Keyword” view information. Views can display live music event information for an artist(s) by name or request to see artist(s) by genre attribution. In other embodiments, Search “for” can also be . . . Search for Venue, Search for Neighborhood, Search for Events, Search for Deal, Search for Merchandise, Search for Dinner and Drink in the neighborhood (e.g., dinner, drink, activity options and deals in the geo-fenced concert neighborhood).

FIG. 12 includes an exemplary screenshot 1200 of the application displaying exemplary “Buzzing Events” view information. By selecting the Buzzing tab 1210, upcoming events are listed based on a “buzz” score. The buzz score can be based on real time buzz and social media popularity from across the Internet. For example, the application can monitor Facebook friend counts, audio track plays, video views, tweets, and other social mentions. The buzz score is an indication of “hotness,” trending, and familiarity to identify the next big thing. The buzz score may also be weighted by other factors, such as, e.g., trending social buzz with local market activity, shares, additions to My Picks, and tastemakers recommendations. Each event possesses a buzz score. Those events with scores above a predetermined threshold may be shown on the buzzing list and may be identified with the “on fire” (flame) icon 1220.

FIG. 13 includes an exemplary buzzing score calculation flowchart 1300. Determining a buzz score for artists playing upcoming events is a programmatic mechanism to show high-interest upcoming artists/events to live music fans. Instead of showing all events, buzzing can provide a preferentially ordered view of events—programmatic curation. An exemplary method of calculating an exemplary buzz score for an artist playing an upcoming event is shown in flowchart 1300. The calculation starts at block 1305, where the comprehensive live music event relational data store is accessed for an artist ID.

The buzz calculation algorithm starts at block 1310 and may include three components: (1) national buzz; (2) local fan buzz; and (3) live music evangelist (VIP) buzz. In block 1315, national buzz can be determined by using the artist ID to call an artist social media metric source (e.g., Echonest, Next Big Sound, MusicMetric, etc.) for a value identifying the following: Low Familiarity & High Hotness (e.g., New emerging artist); High Familiarity & Low Hotness (e.g., established artist, not hot now, but was likely previously hot); or High Familiarity & High Hotness (e.g., the most visible artists touring today). The data call to the artist social media music metric source can return a value for hotness and familiarity that is expressed as a percentage (between 0.0 and 1.0). If the sum of familiarity and hotness is greater than 1.0, then the event is determined to have national buzz—it has either high familiarity or high hotness or both. If an event has national buzz, the application can add 2 points to its buzz score.

In block 1320, local fan buzz can be determined for the specific event that the artist is playing. Based on if the event is shared by site visitors, a numeric value can be earned toward the buzzing calculation. The local buzz weight can be determined based on the market where the artist is playing the event and if resulting fan event shares occur. Event share points can also be earned based on regional shares (e.g., as the artist tour occurs, if buzz and comments build, prior date share points can be added to future date scores to reward artists gaining fan momentum). Local buzz can be based on the number of local market user event shares. Each time the event is shared by a unique user, the event can earn a point. Total points can be tracked and when the point total exceeds the local buzz threshold, then we consider the event to have local buzz. An exemplary point total threshold to determine local buzz is 10 points. If an event has local buzz, then the application can add 1 point to its buzz score. In another embodiment, a prior market local buzz determination can be added to the next stop in the artist tour to recognize momentum building buzz.

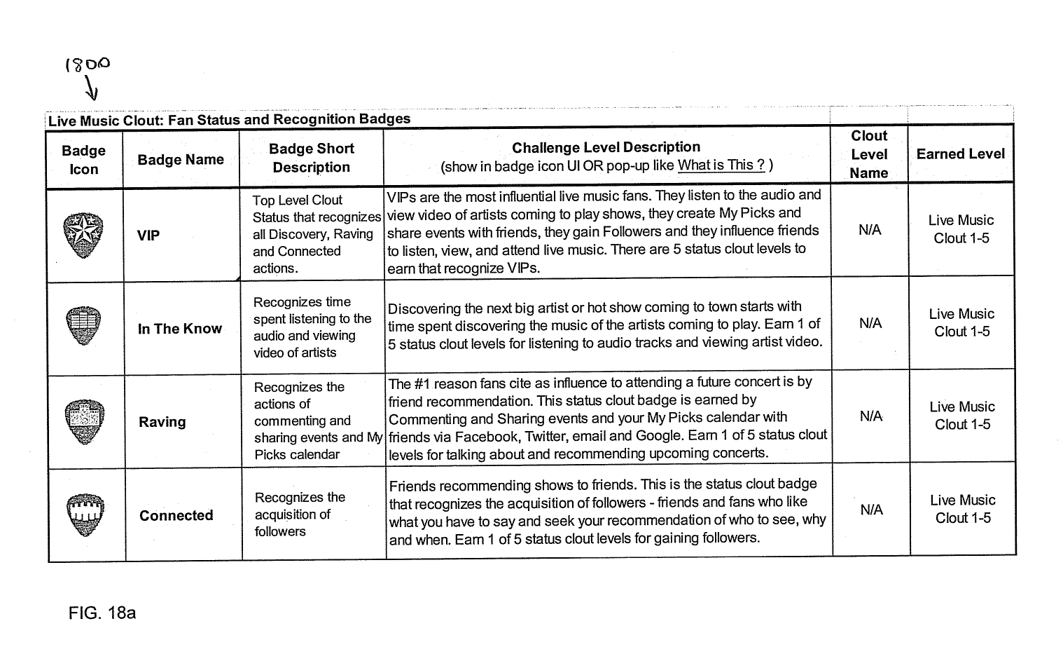

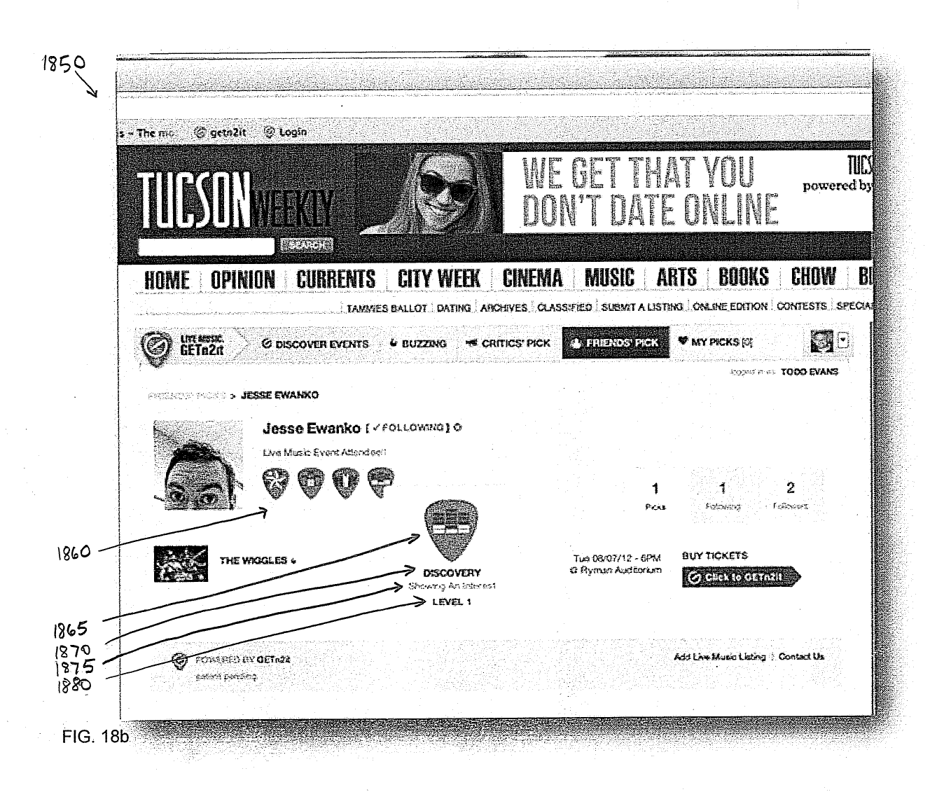

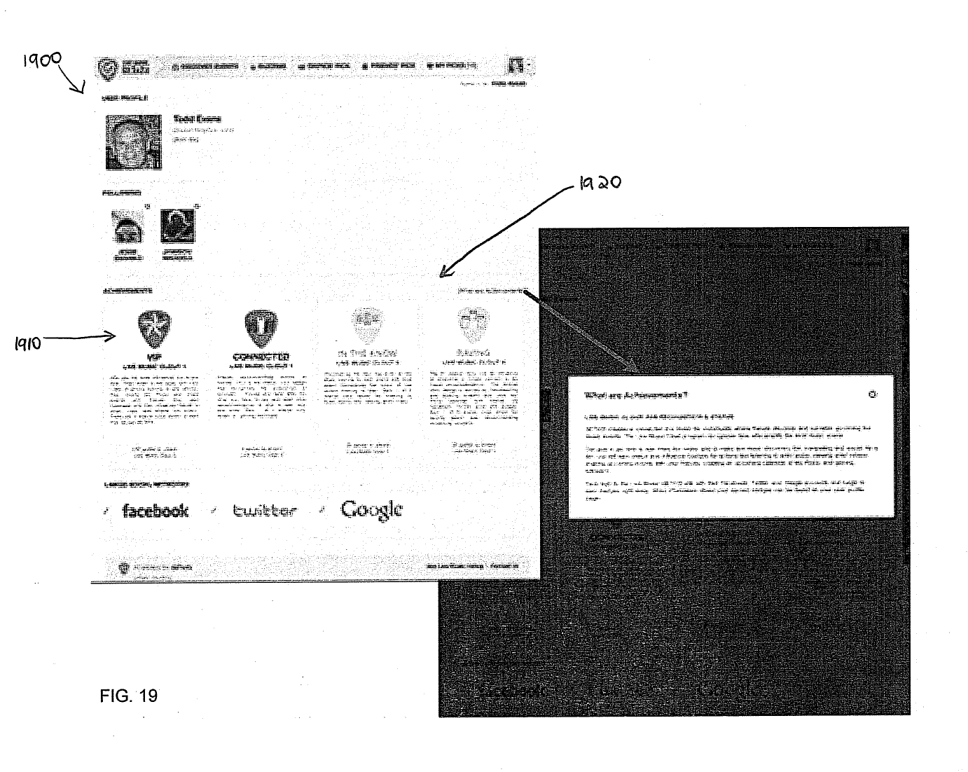

In block 1325, VIP buzz can be determined. Application users who create and share My Picks and acquire followers are important live music VIPs/evangelists. User and referral actions can be tracked such that a user can earn one of five VIP levels. VIPs have followers who value their recommendations and as a result, VIP followers may listen, view, share, and buy. E.g., if a VIP recommends a show, based on their VIP status level (e.g., 1, 2, 3, 4, or 5) a numeric value can be assigned to the buzzing calculation. VIP buzz for an event can be determined based on event recommendation by a user who has earned the VIP Badge. The determination calculation can take into account the average VIP badge level earned (badge level range=1 through 5) by all users who shared the event and compare it to a VIP buzz threshold value. If the average VIP badge level of users who shared an event is >=2, then the event has VIP buzz. If an event has VIP buzz, the application can add 1 to its buzz score. The gamification VIP Badge/Challenge description is discussed in more detail below in association with FIGS. 18 and 19.

A total buzz score is calculated by adding together the three buzz components: (1+2+3)=(4). See table 1345 for an exemplary total buzz score calculation. The scoring algorithm may be flexible to meet current and future needs. For example, events with a total buzz score >0 may be displayed on the buzzing page. Since national buzz is equal to local buzz+VIP buzz, they may balance out if the buzz score is used for sorting. In one embodiment, it may be preferred that the application visually separate the buzz scores for national and local with different icons on the buzz page and allow for distinguishing between events with local interest vs. national interest. This may help to highlight local bands who are gaining local and regional momentum prior to gaining national buzz. In another embodiment, a user may be able to customize the buzz scoring algorithm to tailor the buzz score to meet their own priorities and preferences. For example, a user may be more interested in artists or events with local buzz rather than national buzz.

In block 1330, the application determines whether the total buzz score is above a display threshold. See table 1350 for an exemplary scoring key threshold for displaying an event as a “buzzing” event. If the total buzz score is above the display threshold, the application proceeds to block 1335 and the event will be included in the upcoming “buzzing” live music events. In addition, the total buzz score may be compared to another threshold to determine if the event should be identified with the “on fire” (flame) icon 1220. If the total buzz score is not above the display threshold, the application proceeds to block 1340 and the event will not be included in the upcoming “buzzing” live music events.

FIG. 14 includes an exemplary screenshot 1400 of the application displaying exemplary “friend recommendation” view information. A factor that may significantly influence live music event attendance may be friend recommendations. The application's friend recommendation feature enhances friend recommendations across all social media. As discussed above, a user can then click an event “heart” or “add event to My Picks” button to add events to their My Picks page. Users can comment on their shows and share their picks across social media with their friends. By selecting the “Friends' Pick” tab 1410, events picked by the user's social friends are listed.

Similarly, FIG. 15 includes an exemplary screenshot 1500 of the application displaying exemplary “Critics' Pick” view information. By selecting the “Critics' Pick” tab 1510, events picked by critics are listed. Critics' Pick calendars are created in the same manner as Friends' Pick calendars. The difference is that the Expert or Critic may have an editorial point of view that they are promoting or enhancing with the Critics' Pick calendar. For example, a local media publication or media (e.g., local alternative newsweekly publication, or radio station, etc.) may have music editors, writers, commentators, on-air personalities, etc. who express an editorial point of view or recommendation about upcoming live music events. Critics' Pick calendars may be embedded as a feature of the editorial publication or media.

In exemplary screenshot 1500, two exemplary critics 1520 for the exemplary local media publication in Tucson, Ariz. and their upcoming event picks are shown. Banners that indicate that the pick is an official publication pick and provide the application user with an easy mechanism to see “Go see” shows as recommended by the local media may also be included.

FIG. 16 includes an exemplary screenshot 1600 of the application displaying exemplary “one event page” view information and artist 1605 and supporting artist 1607 tabs. FIG. 17 includes an exemplary screenshot 1700 of the application displaying exemplary “one event page” view information and venue information 1710. The event page views allow a user/fan to discover an upcoming event, the artist(s) playing, and the venue hosting. Other content options and features that may be included in these views include: listen to audio 1610; view video 1620; connect to the artist Facebook, Twitter, Website and other social media destinations 1630; share with friends 1640; see reviews; comment; add to My Picks 1650; buy tickets 1660; and audio tracks 1670.

Referring now to “gamification,” the application may include a game Architecture to create recognition for user/fan actions and activities. Certain specific user actions, when identified and recognized, may contribute to positive business outcomes. A gamification platform can be implemented to track and recognize user activities, such as, e.g., audio plays, video plays, share events with friends, make comments about events, create and share My Picks' calendars, acquisition of followers, and commenting. For example, when users who share their My Picks calendars, additional referral user actions are tracked for establishing influencer clout (e.g., when a fan, shares a pick and their “share-ees” click all of the above user actions). Gamification is a programmatic tool that can identify the most influential live music fans and users of the application. Future usage may involve gifts to influencers and/or provide deals, promos, artist meet-and-greets, etc., and campaigns by artists, venues, and brands.

The gamification platform may include the following features: Social Rank (VIP)—The Social Ranking (clout) challenge can have all of the enabled actions associated with it, including newly defined actions and user actions; Challenge Badges—A set of actions and levels of the same theme and users participate in site challenges by performing actions associated with the challenges; and Points—A unit that is appointed to users when they perform an action on your site, all actions have a point value associated with them. FIG. 18a includes a table 1800 showing exemplary badge names and descriptions. A user can accumulate points to earn virtual rewards, such as levels and badges. Each badge graphic can be provided in an on state (full color) and an off-state (grey color). In addition, there can be five levels per badge provided to correspond with the five earned points levels.

Point System

Within the points system, actions can be throttled so that users can't abuse the system. Exemplary frequency ratings based on current user estimated interaction: High >=2 per visit, Medium=1 per visit, Low <1 per visit. Table 1 below shows exemplary Actions, Frequency, Importance, and associated Point Values.

TABLE 1

| Actions | Frequency | Importance | Point Value (Leave Blank) |
|---|---|---|---|
| Registration | One-Time | High | 0 (Required to participate) |
| Logins | Medium | High | 0 (Required to participate) |
| Comments | Medium | Medium | 5 |
| Acquiring | Medium | High | 10 |
| Followers | | | |
| Referral Traffic | Medium | High | 5 (Only Applies to VIP badge) |
| Actions | | | |
| Listen to Audio | High | High | 5 |
| View Video | High | High | 5 |
| Shares | High | Medium | 10 |

Clout Level

Clout levels determine user VIP rankings. The social VIP rank may be earned by aggregating all points from every action tracked on the site. If the application is using redeemable points to reward active users as well, it may be an excellent indicator of how quickly users are moving through the overall game architecture. Table 2 below shows exemplary Clout Levels, Clout Level Names, and associated Point Milestones, Clout Level Names may be any name—A, B, C, D, and E are shown as examples.

TABLE 2

| Clout Level | Clout Level Name | Point Milestone |
|---|---|---|
| 1 | A | 1,000 |
| 2 | B | 2,500 |
| 3 | C | 5,000 |
| 4 | D | 10,000 |
| 5 | E | 25,000 |

### Challenges

Challenge badges differ from the social rank (VIP) in that they may be associated with just one or very few individual actions on the site. When a challenge is associated with just one action, the user can be notified with the number of actions to complete to reach the next level of that challenge (e.g., 5 more shares to reach level 2). When a challenge is associated with more than one action, the user will see their progress towards the next level in points (e.g., 50 more points to reach level 2).

Exemplary names for challenge badge levels may be Promoter 1, Promoter 2, etc. The application may allow virtually any name.

Challenge Name: Raving

The raving badge may be associated with artist promotion. Table 3 below shows exemplary Challenge Levels, Challenge Level Names, and associated Point Milestones Actions.

TABLE 3
Action(s) Associate: Sharing, Commenting (Earn 10 points per
Share and 5 points per Comment)

| | | Point Milestone Actions |
|---|---|---|
| Challenge Level | Challenge Level Name | (Shares - Comments) |
| 1 | Promoter 1 | 100 |
| | | 10-20 |
| 2 | Promoter 2 | 500 |
| | | 50-100 |
| 3 | Promoter 3 | 1,000 |
| | | 100-200 |
| 4 | Promoter 4 | 2,500 |
| | | 250-500 |
| 5 | Promoter 5 | 5,000 |
| | | 500-1,000 |

Actions show range of: Shares-Comments (left is all shares through all comments on right)

Challenge Name: Connected

The connected badge may be associated with followers. Table 4 below shows exemplary Challenge Levels, Challenge Level Names, and associated Point Milestones Actions.

TABLE 4
Action(s) Associate: Acquiring Followers (10 points earned per follower)

| | | Point Milestone |
|---|---|---|
| Challenge Level | Challenge Level Name | Followers |
| 1 | Promoter 1 | 250 |
| | | 25 |
| 2 | Promoter 2 | 500 |
| | | 50 |
| 3 | Promoter 3 | 1,000 |
| | | 100 |
| 4 | Promoter 4 | 2,500 |
| | | 250 |
| 5 | Promoter 5 | 5,000 |
| | | 500 |

First Connected badge earned with the acquisition of 25 followers

Challenge Name: In The Know

The in the know badge may be associated with artist discovery. Table 5 below shows exemplary Challenge Levels, Challenge Level Names, and associated Point Milestones.

TABLE 5
Action(s) Associate: Audio Plays, Video Plays (5 points
earned per audio or video play)

| Challenge | Challenge Level | Point Milestone |
|---|---|---|
| Level | Name | Total Plays |
| 1 | Promoter 1 | 125 |
| | | 25 |
| 2 | Promoter 2 | 500 |
| | | 100 |
| 3 | Promoter 3 | 1,250 |
| | | 250 |
| 4 | Promoter 4 | 2,500 |
| | | 500 |
| 5 | Promoter 5 | 5,000 |
| | | 1,000 |

First In The Know badge earned with total of 10 plays (combination of audio and video plays)

The application may be modified to add more challenges as necessary.

FIG. 18b includes an exemplary screenshot 1850 of the application displaying exemplary badges 1860 earned by the user while viewing a Friends' Pick page. By hovering over a badge with a selector (e.g., a mouse for a computer), the application may provide more information about the badge, e.g., a larger view of the badge icon 1865, the badge name 1870, the challenge level description 1875, the earned level 1880, and challenge level descriptions (as shown in FIG. 18a). The application may also provide achievement information from the User Profile page, My Live Music Clout:

Use same mouse-over display for badge name, etc. as on My Picks page. The user may eliminate points to unlock next challenge level name (show non-earned locked/grey'ed out badge with Live Music Clout Level 0)

FIG. 19 includes an exemplary screenshot 1900 of the application displaying exemplary badges earned by the user 1910 and badges available to be earned 1920.

As discussed above (and as shown in FIG. 1), the application can build a comprehensive live music event ecosystem database, display live music event information in a variety of ways, and optimize a single destination hub for live music events in each local market to optimize communication and commerce for live music events. The result of these steps is that each local market can possesses a single comprehensive live music event hub and ecosystem workflow to optimize acquisition and display of event, venue, artist, recommendation, buzzing, and friend socialization in and around live music events. A self-optimizing network effect can be created where the local live music event hub incents participation by the local ecosystem participants (e.g., venues, artists coming to play events, local media, fans, as well as restaurants, bars, brands, etc. who seek access to fans at live music events) to provide information, data, and editorial point of view about upcoming events. This includes, for example, local hub marketing, communication, awareness, and additional commerce workflow.

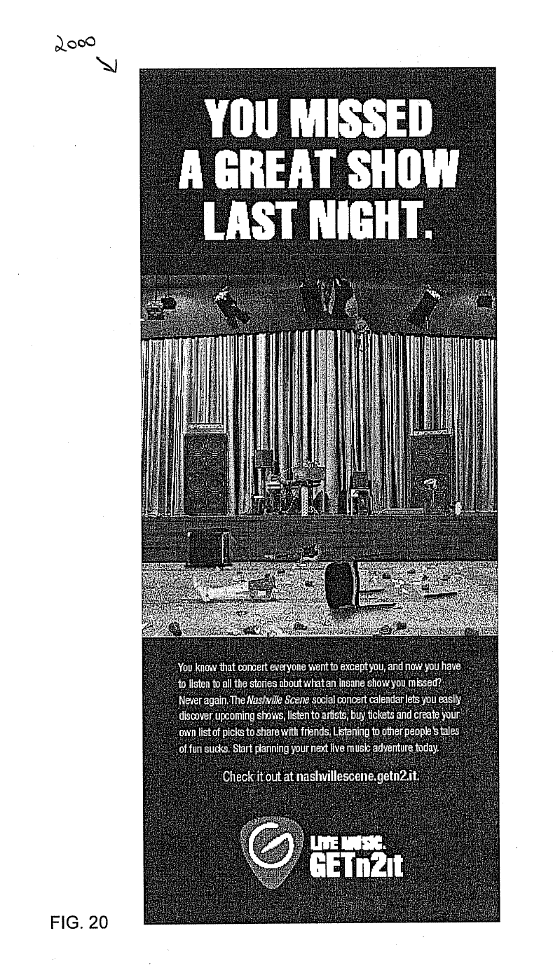

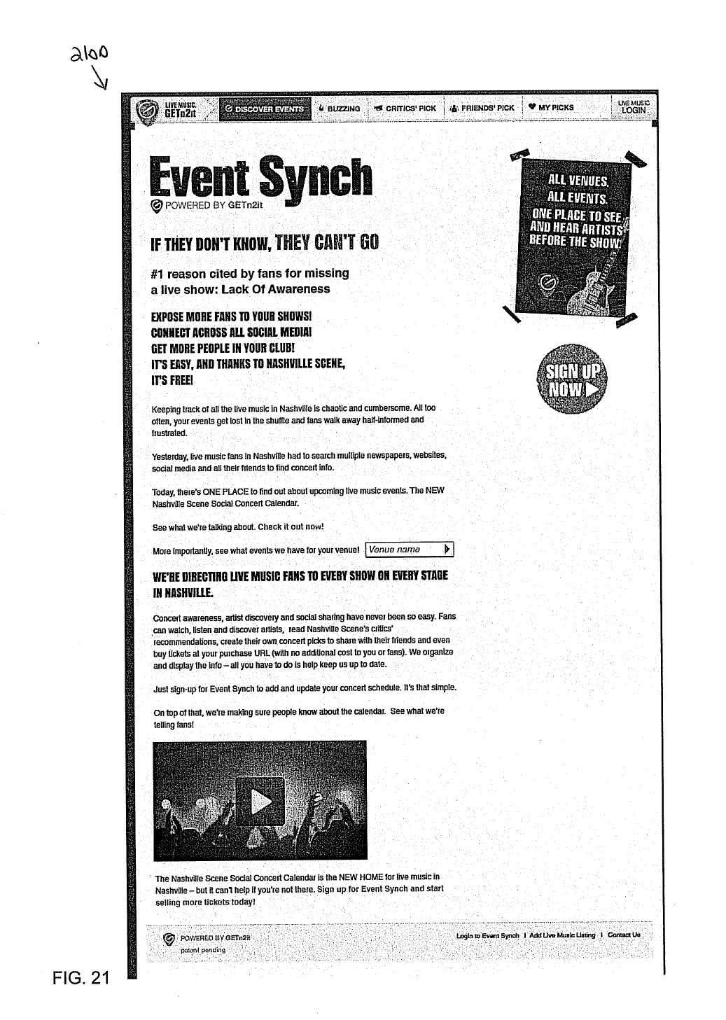

In some embodiments, use of the application (e.g., GETn2it Hub) may be free in return for local hub marketing that self-reinforces (e.g., through print advertisements marketing GETn2it the web application and the mobile application) the local media publications (e.g., alternative newsweekly publications), banners sponsored by brands to download the local live music application (to be placed on venue walls), and use of the Event Synch application provided to venues and promoters. FIG. 20 includes an exemplary depiction 2000 of an exemplary advertisement associated with the application. In this example, the half page advertisement may be placed each week in an alternative newsweekly publication (e.g., the Nashville Scene) marketing the exemplary application—GETn2it. FIG. 21 includes an exemplary depiction 2100 of another exemplary advertisement associated with the application. In this example, Event Synch is an application tool geared for venues and promoters to place their events in the GETn2it application. The Event Synch advertisement highlights an exemplary local market video created to incent fans to come to the application for a new one-stop place for local live music.

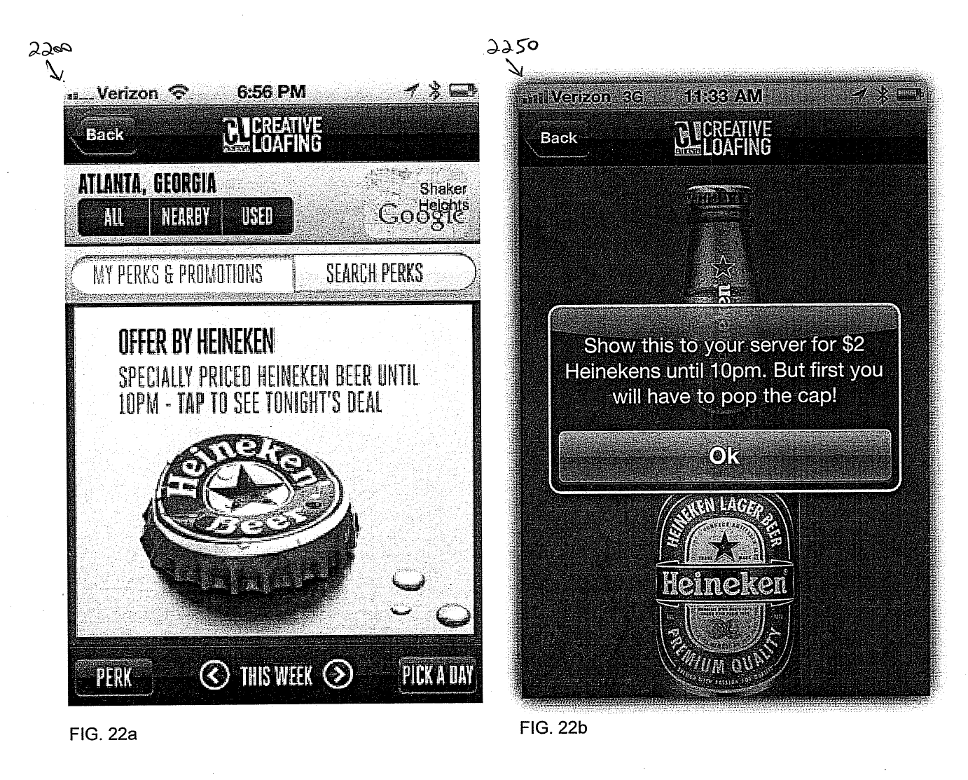

The application may also include a Dinner & Drink in the Concert Neighborhood and Deals Platform. FIG. 22a includes an exemplary screenshot 2200 of the application displaying an exemplary promotion offered to a user of the application. FIG. 22b includes an exemplary screenshot 2250 of the application displaying another exemplary promotion offered to a user of the application. These exemplary promotions may be part of the Dinner & Drink in the Concert Neighborhood and Deals Platform offered via the application directly to users. The application's web, social, and mobile advertisement platform can leverage geo fencing of venues and neighborhoods to deliver national brand and local advertiser deals to fans who come into the concert neighborhood (e.g., as determined by a mobile device location) and to offer venue deals, such as, e.g., concert tickets.

Based on permissions and legality of deals, the application may allow users to opt in to receive dinner, drink, ticket and artist promotions and deals to their mobile device, e.g., in general, day of show, or when their mobile device enters a live music event concert neighborhood. Deals offered by the application may be for local restaurants, bars, and advertisers, as well as national brands and artists.

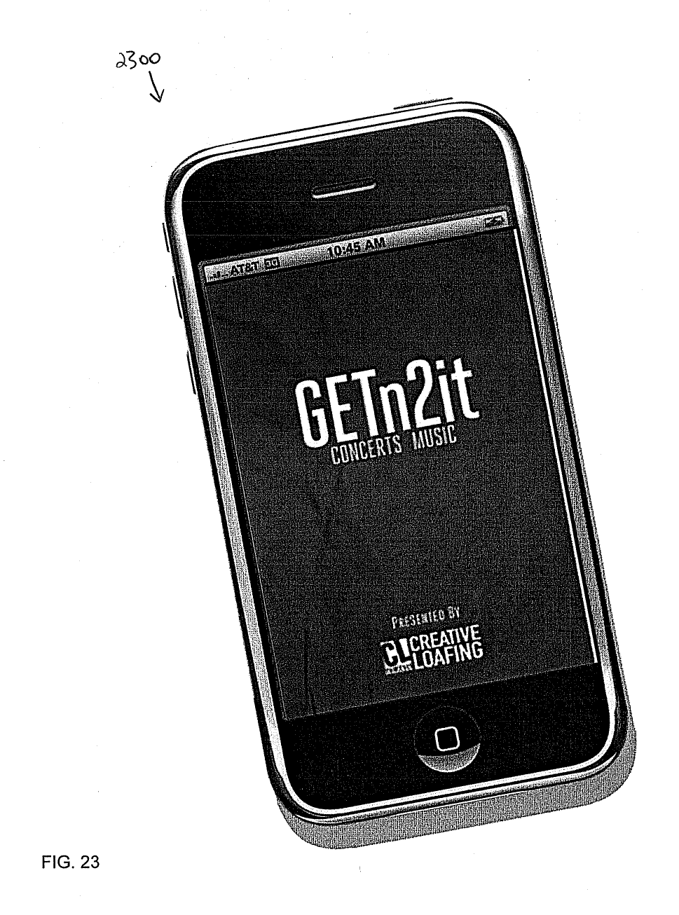

FIG. 23 includes an exemplary screenshot 2300 of the application displaying an exemplary locally branded version of the application. An exemplary mobile application, the GETn2it Concert Calendar application, may be designed to be branded for the local market.

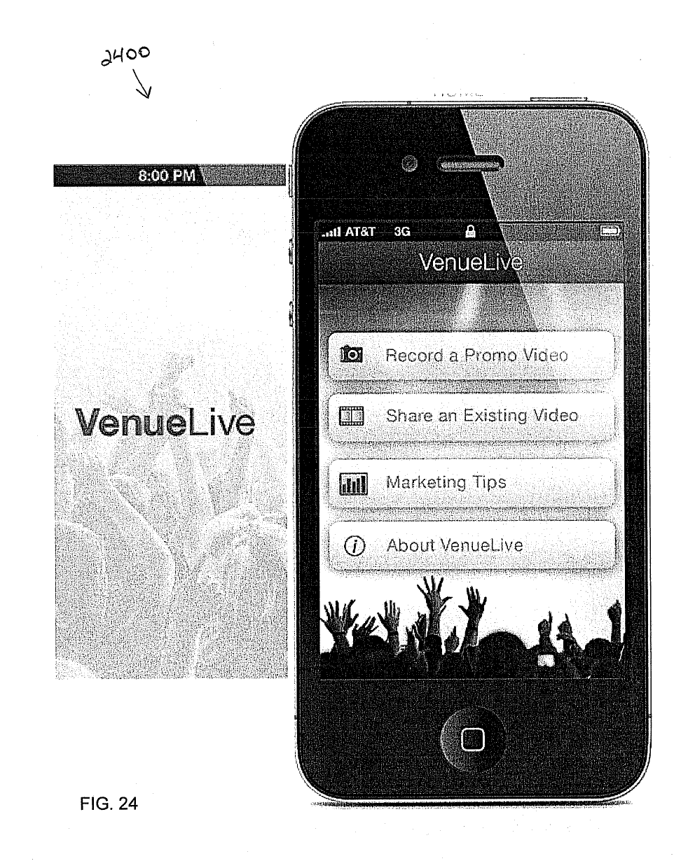

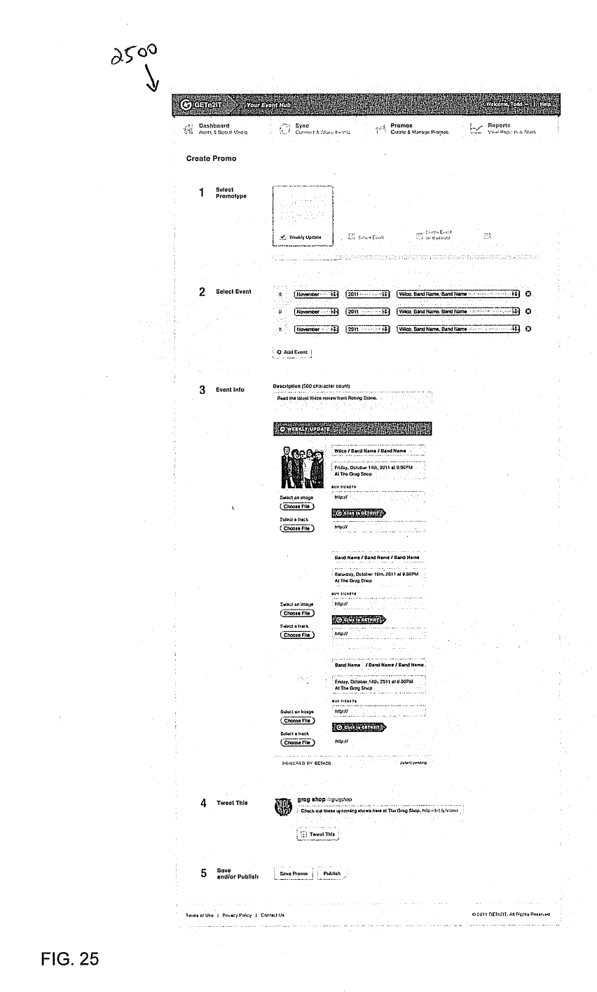

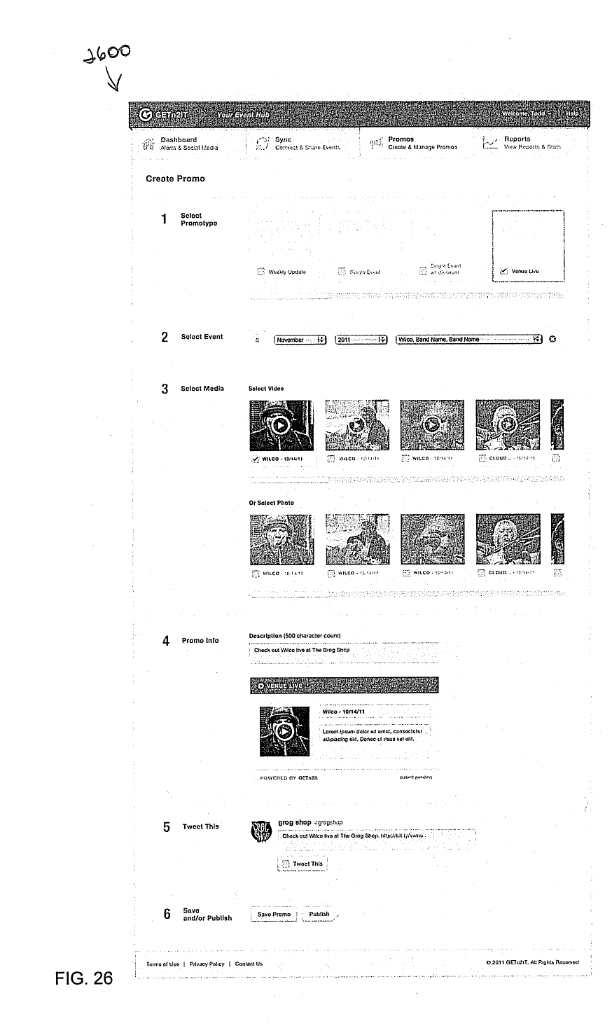

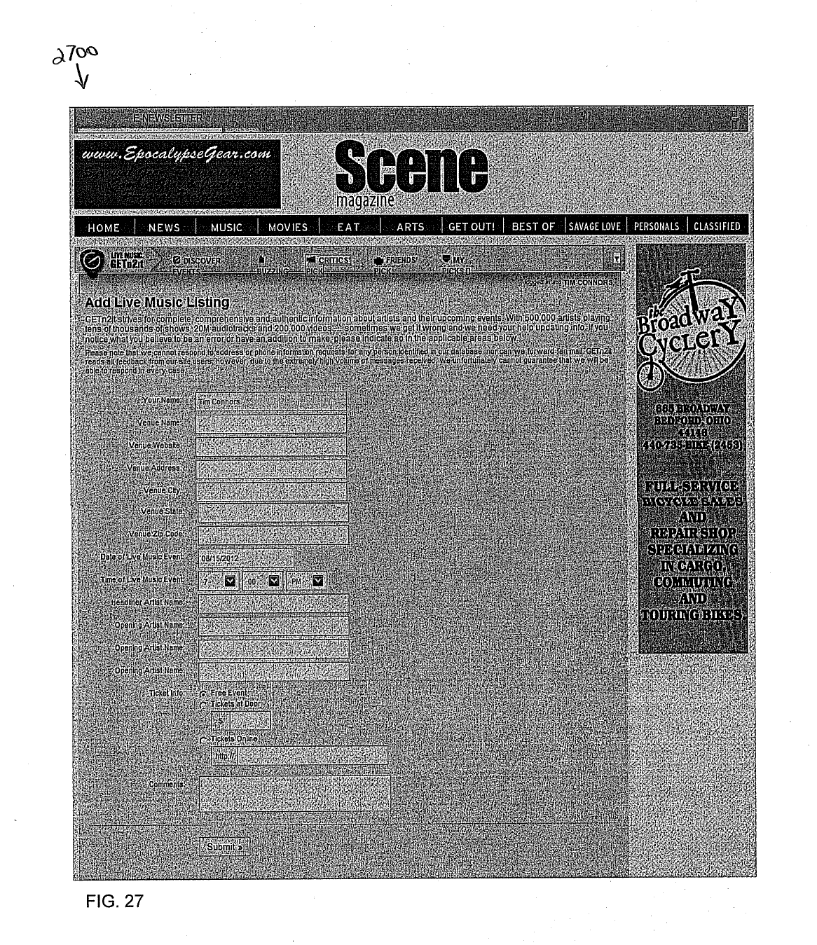

The application may also include various marketing tools that may be provided, e.g., free of charge, to venues and artists to market their events and deals via the local event hub (application). This strategy may be designed to create a self-reinforcing network effect around the application. FIG. 24 includes an exemplary screenshot of the application displaying an exemplary interactive promotional tool 2400 for capturing and sharing media. VenueLive, e.g., can be an interactive tool designed to capture event marketing and deals, and then share them, e.g., via social media and through the application and fan mobile devices. In practice, for example, a live from the road (or VenueLive) application tool can be designed to capture an artist en route to a local event, record interesting audio and video content, and share this content via social media to instill excitement and event awareness. In addition, the content may include links to ticket purchase URLs to facilitate selling more tickets and merchandise deals for use in the venue during the concert event. FIG. 25 and FIG. 26 include exemplary screenshots 2500, 2600, respectively, of the application displaying exemplary views of another promotion creation tool, which can allow the user (e.g., promoter, artist, etc.) to select a promotional type, associate the promotion with an event, and share the promotion, e.g., via social media.

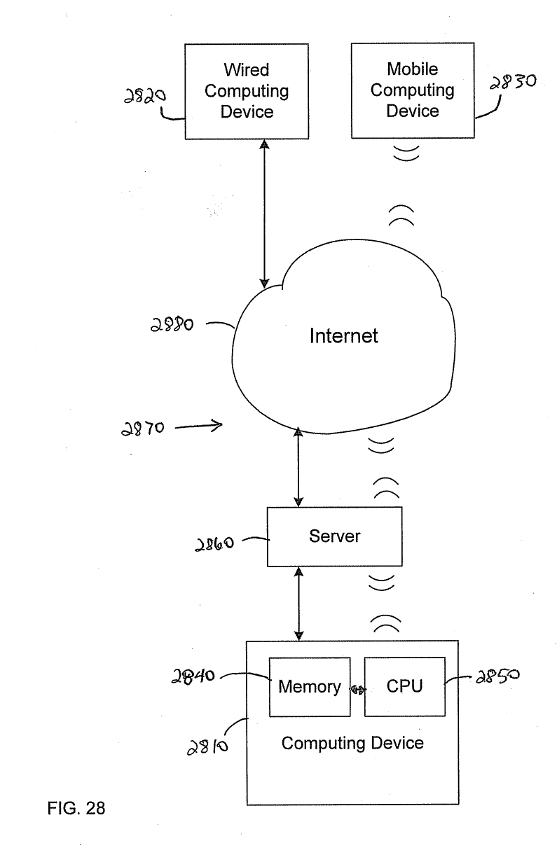

FIG. 28 includes an exemplary depiction of exemplary communication protocols and exemplary devices containing the application. The application may be executed on a variety of computing devices 2810, including, e.g., wired devices 2820 (e.g., desktop computers) and mobile devices 2830 (e.g., smartphones and tablets), kiosks, or any other device capable of hosting or presenting the application to a user with a display and input mechanism. The application may be stored in the memory 2840 of a device and processed by a Central Processing Unit (CPU) 2850. The application may be stored and accessed via the same device, stored remotely in a first device and accessed via a different second device, or any other combination thereof. The application may be stored in local or remote memory (e.g., of a server 2860), and accessible directly or via a network 2870 (e.g., over the internet 2880). The application may also be a web-based application accessible via the internet 2880. A database associated with the application may be located in the same or different memory location than the application. Similarly, a database associated with the application may be accessed the same way or differently than the application.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

Names and images related to certain artists, venues, potential sponsors, and other third parties are used in the submitted materials solely to demonstrate how the system would display or otherwise manage such categories of information. Neither In2une LLC nor its products or services are sponsored, approved or endorsed by, or otherwise associated with, any such artists, venues, potential sponsors or other third parties.

We claim:

1. A method for optimizing communication about entertainment events, comprising:
acquiring entertainment event data from a plurality of data sources;
acquiring artist data, wherein the artist is associated with the entertainment event;
acquiring social media data, including a measure of social activity associated with the entertainment event or artist;
providing an application that allows a user of the application to access information associated with the entertainment event, including location, date, time, tickets, venue, samples of the artist material, advertisements, promotions, articles, merchandise, or related events, wherein the user can save their favorite venues or artists, flag upcoming events, access special promotions, or share their plans and interests via social media; and
creating a database, wherein the database includes information related to users, events, artists, venues, advertisers, or publications.
